(19) United States
(12) Patent Application Publication
(10) Pub. No.: US 2011/0045139 A1
(43) Pub. Date: Feb. 24, 2011

(54) FERMENTED SAUSAGE AND METHODS OF MAKING SAME

(75) Inventors: RICHARD A. HOLLEY, Winnipeg (CA); Fernando B. Luciano, Winnipeg (CA)

Correspondence Address: MUETING, RAASCH & GEBHARDT, P.A., P.O. BOX 581336, MINNEAPOLIS, MN, 55458-1336, US

(73) Assignee: University of Manitoba, Winnipeg (CA)

(21) Appl. No.: 12/858,815

(22) Filed: Aug. 18, 2010

Related U.S. Application Data
(60) Provisional application No. 61/234,934, filed on Aug. 18, 2009.

(51) Int. Cl. A23L 1/314; A23L 1/317

(52) U.S. Cl. 426/59; 426/646

(57) ABSTRACT

The present invention provides methods for producing a fermented sausage, such as a semi-dry or dry fermented sausage. The methods include adding to a sausage batter a processed mustard, where the processed mustard may include characteristics chosen from a total phenolic content of at least 21 mg FAE/gram processed mustard, an antioxidant capacity of at least 900 micromol/100 grams processed mustard, no detectable myrosinase activity, and a combination thereof. The present invention also provides fermented sausage, such as a dry fermented sausage, that includes vegetable protein. The vegetable protein may be at a level of at least 0.01% (wt/wt).

### CROSS-REFERENCE TO RELATED APPLICATIONS

This application claims the benefit of U.S. Provisional Application Ser. No. 61/234,934, filed Aug. 18, 2009, which is incorporated by reference herein.

### BACKGROUND

Fermentation and drying are among some of the first methods used to preserve foods for extended storage. Dry fermented sausage has been traditionally produced using raw meat without thermal processing. The multiple hurdles present in this type of product are able to prevent or reduce the growth of spoilage bacteria, resulting in a shelf-stable food. These hurdles include: pH drop produced by the fermenting bacteria, commonly lactic acid bacteria (LAB); reduction of the water activity (a_{w}) during drying; and addition of antimicrobial compounds such as salt, nitrite and spices (Lucke, 1986. Fleischwirtschaft 66, 1505-1509). Unfortunately, some pathogenic organisms can overcome these barriers and survive in this type of product without causing sensory alteration. The most prominent of these pathogens is E. coli O157:H7. This organism has been shown to grow at low pH (4.0-4.5) (Buchanan and Bagi, 1994. International Journal of Food Microbiology 23:317-332) and even survive in very acidic environments (pH 1.5-3.0) (Arnold and Kaspar, 1995. Applied and Environmental Microbiology 61:2037-2039). Moreover, E. coli O157:H7 has pronounced salt tolerance, being able to survive in sausage containing 4.4-4.8% NaCl (Hinkens et al., 1996. Journal of Food Protection 59:1260-1266; Riordan et al., 1998. Journal of Food Protection 61:146-151). Low a_{w} is another feature that prevents microbial spoilage in dry sausage, and E. coli requires a minimum a_{w} of 0.95 for proper growth (Sperber, 1983. Journal of Food Protection 46:142-150). A few studies demonstrated that the combination of low pH/low a_{w} found in dry fermented sausage was able to significantly reduce the population of E. coli O157:H7 (1-2 log CFU/ml), but this was insufficient to eliminate the pathogen when present at high levels (Chacon et al., 2006. Applied and Environmental Microbiology 72:3096-3102; Graumann and Holley, 2008. Journal of Food Protection 71:486-493).

The first reported outbreak involving E. coli O157:H7 in dry fermented sausage occurred in 1994, when this pathogen sickened 17 individuals after their consumption of pre-sliced dry salami (Tilden et al., 1996. American Journal of Public Health 86, 1142-1145). Other similar outbreaks have occurred where hundreds of people have been sickened and several deaths have been reported (MacDonald et al., 2004. Epidemiology and Infection 132, 283-289; Williams et al., 2000. Canadian Medical Association Journal. 162:1409-1413). These outbreaks led food regulatory agencies in both Canada (Canadian Food Inspection Agency, 1999. Meat 596 Hygiene Manual of Procedures. Chapter 4.10.15 (pp 48-72)) and the US (Reed, 1995. Challenge study Escherichia coli O157:H7 in fermented sausages. U.S. Department of Agriculture, Food Safety and Inspection Service, 741 Washington, D.C. (Letter to plant managers)) to adopt very strict rules for the manufacture of dry fermented sausage products, requiring production processes to cause >5-log CFU/g reduction of the E. coli O157:H7 population. Presently, most of the processes used to assure the absence of this bacterium from dry fermented sausage rely on raw ingredient and final product testing; involve extension of the ripening period or use cooking. However, cooking alters sensory properties and reduces the market value of these products. Extending storage increases inventory cost and is not an effective means for eliminating E. coli O157:H7 from dry sausage. Mustard seeds and mustard powder have been used as common spices in fermented sausages. Both Sinapis alba (yellow or white mustard) and Brassica juncea (brown and oriental mustard), the main botanical species of mustard, contain high levels of glucosinolates. These are secondary metabolites that have their thioglucoside bond cleaved by an intrinsic mustard enzyme, myrosinase (EC 3.2.1.147) in the presence of moisture, forming isothiocyanates plus thiocyanates, nitriles and some other minor compounds. In yellow mustard, myrosinase forms ρ-hydroxybenzyl isothiocyanate (ρ-HBIT) from the principal glucosinolate present, sinalbin.

Recently, isothiocyanates and ground mustard have been tested in meat products for their ability to eliminate E. coli O157:H7 (Chacon et al., 2006. Applied and Environmental Microbiology 72:3096-3102; Muthukumarasamy et al., 2003. Journal of Food Protection 66, 2038-2044; Nadarajah et al., 2005. Food Microbiology 99, 269-279). Both treatments significantly reduced the levels of the pathogen in meat products, including dry fermented sausage, but they can generate hot/pungent flavors in the final product (Chacon et al., 2006. Applied and Environmental Microbiology 72:3096-3102). In the 90's, Canadian-based UFL Foods introduced a thermal process for inactivation of myrosinase in yellow mustard seeds. After grinding, the mustard powder (also known as cold or deodorized powder) yielded an ingredient with excellent emulsifying, bulking, stabilizing and thickening properties, but lacking the intense hot flavor normally caused in yellow mustard by ρ-HBIT (Cui and Eskin, 1998. In: Mazza et al. (Eds.), Functional foods: biochemical and processing aspects. CRC Press, Boca Raton, Fla., pp. 235-245). This novel ingredient has been accepted and extensively used by the meat industry in cooked processed products because the powder improves water holding capacity, facilitates emulsion formation, has high protein content and is not expensive.

Very few studies have examined the potential for use of yellow mustard powder and/or ρ-HBIT to eliminate microbial pathogens from food products. Examination of the antimicrobial effects of purified ρ-HBIT has been difficult due to its significant instability (Kawakishi et al., 1967. Agricultural and Biological Chemistry 31:823-830), and difficulties in the extraction of the essential oil (Buskov et al., 2000. Journal of Biochemical and Biophysical Methods 43157-174). In addition, very few commercial suppliers of sinalbin and ρ-HBIT are available, and usually the quantities sold are very limited. Ekanayake et al. (Ekanayake et al., 2006. Acta Horticulturae 709, 101-108) showed that ρ-HBIT had significant bactericidal activity against several foodborne pathogens including Escherichia coli, Staphylococcus aureus, Campylobacter jejuni, Pseudomonas aeruginosa, Salmonella Enteritidis, Listeria monocytogenes, Shigella boydii and Clostridium perfringens at 0.35-2.13 mM.

Muthukumarasamy et al. (Muthukumarasamy et al., 2004. Presented at the 50th 724 International Congress of Meat Science and Technology, Helsinki, Finland) tested the antimicrobial effect of hot (active myrosinase) and cold mustard powder on the growth of E. coli O157:H7. A 5-strain mixture of the bacteria was inoculated in ground beef at 3 log CFU/ml and stored at 4° C. The hot mustard powder eliminated the pathogen after 3 days when used at 20% (wt/wt), whereas 18 days were needed when it was added at 10%. The cold powder had no effect on the population of E. coli O157:H7. More recently, Graumann and Holley (Graumann and Holley, 2008. Journal of Food Protection 71:486-493) added yellow mustard powder to dry cured sausages in an attempt to kill E. coli O157:H7. When the hot and cold flour were tested at 6% (wt/wt), 24 days were required for the hot flour to reduce the population of the pathogen >5 log CFU/g. Interestingly, 6% cold mustard powder showed an unexpected and significant reduction in E. coli O157:H7 viability to levels less than the detection limit (>5 log CFU/ml reduction) in only 6 days. Since the cold powder had lost its myrosinase activity, it could not have produced isothiocyanates, intrinsically.

Apart from isothiocyanates, mustard seeds produce other metabolites with antimicrobial and antioxidant properties such as phenolic acids and phytin (Cui and Eskin, 1998. In: Mazza et al. (Eds.), Functional foods: biochemical and processing aspects. CRC Press, Boca Raton, Fla., pp. 235-245). Extracts from deodorized yellow mustard powder were shown to have significant antioxidant activity, even in meat, and this was believed mainly due to the presence of phenolic compounds (Saleemi et al., 1993. Journal of Food and Agricultural Chemistry 41:641-643; Shahidi et al., 1992. In: Ho et al., (Eds.). Phenolic Compounds in Foods and Their Effect on Health. ACS Symposium Series 506, Washington, pp. 214-222). These reports indicated that the major phenolics present in Sinapis alba were ρ-hydroxybenzoic acid and sinapic acid, which combined represented 36% of the total phenolics. Dabrowski and Sosulski (Dabrowski and Sosulski, 1984. Journal of Agricultural and Food Chemistry 32:128-130) reported even higher values. A variety of studies have reported that some processes applied to foods, such as cooking under pressure, can increase the levels of free phenolic acids in the final product (Gliszczynska-Swiglo et al., 2006. Food Additives and Contaminants 23, 1088-1098; Ju et al., 2010. Food Chemistry 119:619-625; Rhandir et al., 2008. Innovative Food Science & Emerging Technologies 9:746 355-364). Gliszczynska-Swiglo et al. (Gliszczynska-Swiglo et al., 2006. Food Additives and Contaminants 23, 1088-1098) showed that steaming broccoli not only increased the levels of phenolic acids, but also yielded higher amounts of vitamin E and β-carotene than when raw.

### SUMMARY OF THE INVENTION

The present invention provides methods for producing a fermented sausage. The methods may include adding to a sausage batter a processed mustard to form an unfermented mixture. The processed mustard may include characteristics chosen from a total phenolic content of at least 21 mg FAE/gram processed mustard, an antioxidant capacity of at least 900 micromol/100 grams processed mustard, no detectable myrosinase activity, or a combination thereof. The processed mustard may be added to the sausage batter as a composition, where the composition may include processed mustard and a hot or a cold mustard. The composition that includes the processed mustard and the hot mustard or the cold mustard may include at least 50% (wt/wt) processed mustard. The processed mustard may include a total phenol content of at least 23 mg FAE/gram processed mustard, and/or an antioxidant capacity of at least 1200 micromol/100 grams processed mustard.

The methods may include incubating the unfermented mixture under conditions suitable for fermentation to result in a fermented mixture, and then incubating the fermented mixture under conditions suitable for drying the fermented mixture to produce a fermented sausage. The fermented sausage has a pH of no greater than 5.3, and/or a water activity of no greater than 0.9. The fermented sausage may have a moisture protein ratio of no greater than 3.2:1, or a moisture protein ratio of no greater than 1.9:1.

The processed mustard used in the method may be produced by exposing a mustard having detectable myrosinase activity to a temperature of between 70° C. and 120° C. For instance, the processed mustard may be produced by exposing a mustard having detectable myrosinase activity to a temperature of at least 70° C. for at least 5 minutes.

The methods may further include adding a composition that includes a fermenting microbe, such as a lactic acid microbe.

The methods may further include testing for the presence of a pathogenic microbe. Any component may be tested at any stage. For instance, the unfermented mixture or the fermented sausage may be tested. The pathogenic microbe may be E. coli, such as an E. coli O157:H7, a member of the genus Staphylococcus, a member of the genus Campylobacter, a member of the genus Pseudomonas, a member of the genus Salmonella, a member of the genus Listeria, a member of the genus Shigella, a member of the genus Clostridium.

The present invention also provides fermented sausage. A fermented sausage, such as a dry fermented sausage, may include vegetable protein at a level of at least 0.01% (wt/wt). A fermented sausage, such as a dry fermented sausage, may include vegetable protein, where the difference between the total protein and the total protein derived from meat is at least 0.5%.

The term “and/or” means one or all of the listed elements or a combination of any two or more of the listed elements.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The terms “comprises” and variations thereof do not have a limiting meaning where these terms appear in the description and claims.

Unless otherwise specified, “a,” “the,” and “at least one” are used interchangeably and mean one or more than one.

Also herein, the recitations of numerical ranges by endpoints include all numbers subsumed within that range (e.g., 1 to 5 includes 1, 1.5, 2, 2.75, 3, 3.80, 4, 5, etc.).

For any method disclosed herein that includes discrete steps, the steps may be conducted in any feasible order. And, as appropriate, any combination of two or more steps may be conducted simultaneously.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE FIGURES

FIG. 1. Hydrolysis of sinalbin by pork exudate (∘), beef exudate (▪), Staphylococcus carnosus (□), Pediococcus pentosaceus (▴) and E. coli O157:H7 cocktail (♦). Reduction of sinalbin levels was analyzed by HPLC and quantified by comparison to a 2.36 mM sinalbin standard. The commercial spice mix had no negative effect on sinalbin stability (result not shown).

FIG. 2. Bacterial population in Muller-Hinton broth containing the dry ingredients used for the production of dry-fermented sausages. A broth containing YMF (Δ) was compared to a control (▪) using the same incubation conditions (25° C. and 200 rpm). A) represents the population of E. coli O157:H7, E. coli O157:H7 was also incubated in the presence of myrosinase (0.2 U/tube) and YMF (♦); B) P. pentosaceus; and C) S. carnosus. Bacterial enumeration was done in VRB agar (E. coli), MSA agar (S. carnosus) and MRS agar (P. pentosaceus).

FIG. 3. HPLC chromatogram of sinalbin (RT˜5.2 min) in the presence of the intracellular fraction from E. coli O157:H7 at 0 h (A) and 72 h (B). The arrow at RT=12.9 min (B) represents the formation of the cyanate ion (SCN⁻).

FIG. 4. Degradation of sinigrin by Staphylococcus carnosus (□), Pediococcus pentosaceus (▴) and E. coli O157:H7 cocktail (♦). Reduction of sinigrin levels was analyzed by HPLC and quantified by comparison to a 2.5 mM sinigrin standard.

FIG. 5. Population of E. coli O157:H7 in Muller-Hinton broth containing the dry ingredients used for the production of dry-fermented sausages. The bacteria were incubated (25° C. and 200 rpm) in the presence of myrosinase (0.2 U/tube) and either 2.5 mM of sinigrin (Δ) or 2.5 mM of sinalbin (▪). Bacterial enumeration was done on VRB agar.

FIG. 6. Total phenolic content of hot, cold and autoclaved mustard powder. Values are presented in mg ferulic acid equivalent (FAE) per g mustard powder. Different letters represent a significant difference (P<0.05) among treatments.

FIG. 7. Antioxidant activity of hot, cold and autoclaved mustard powder using the DPPH method. Results are measured in μM of Trolox Equivalent per 100 g of mustard powder. Different letters represent a significant difference (P<0.05) among treatments.

### DETAILED DESCRIPTION OF ILLUSTRATIVE EMBODIMENTS

The present invention includes methods for making fermented sausage, including dry and/or semi-dry fermented sausage. The methods include the use of a processed mustard. The use of processed mustard may provide several advantages including a food safety benefit of decreased contamination of fermented sausage with pathogenic microbes, and an economic benefit from decreased need for validation of procedures to ensure absence of pathogenic microbes.

A processed mustard useful in the present invention has several characteristics. For instance, a processed mustard has a total phenol content that is at least 21 milligram (mg) ferulic acid equivalent (FAE) per gram processed mustard (mg FAE/g), at least 21.5 mg FAE/g, at least 22 mg FAE/g, at least 22.5 mg FAE/g, at least 23 mg FAE/g, at least 23.5 mg FAE/g, at least 24 mg FAE/g, at least 24.5 mg FAE/g, at least 25 mg FAE/g, or at least 25.5 mg FAE/g processed mustard powder. A processed mustard may have a total phenol content that is no greater than 26 mg FAE/g, no greater than 26.5 mg FAE/g, or no greater than 27 mg FAE/g. Methods for measuring the total phenol content of a mixture such as a mustard powder are known in the art and routinely used. Preferably, the Folin-Ciocalteau method (Gao et al., 2002, In: Ng, P., Wrigley, C. W. (Eds.), Wheat quality elucidation. AACC Press, St. Paul, Minn., pp. 219-233) is used as described in Example 3.

A processed mustard useful in the present invention also has an antioxidant capacity of at least 900 micromolar (micromol or μmol) Trolox Equivalents (TE) per 100 grams processed mustard (micromol TE/100 g), at least 950 micromol TE/100 g, at least 1000 micromol TE/100 g, at least 1100 micromol TE/100 g, at least 1150 micromol TE/100 g, at least 1200 micromol TE/100 g, or at least 1250 micromol TE/100 g processed mustard powder. Trolox is the tradename for 6-hydroxy-2,5,7,8-tetramethylchroman-2-carboxylic acid (CAS registry number 53188-07-1), a water-soluble derivative of vitamin E. Trolox equivalents are routinely used to express the antioxidant capacity of a mixture. Methods for measuring the antioxidant capacity of a mixture such as a mustard powder are known in the art and routinely used. Preferably, the 2,2-diphenyl-1-picrylhydrazyl (DPPH) method is used. A preferred example of the DPPH method is a modification of Chen and Ho (1995, Journal of Food Lipids 2:35-46) as described in Example 3.

A processed mustard useful in the present invention has the characteristic of having glucosinolates. An example of one glucosinolate typically found in mustard powder is sinalbin, which is typically found in yellow mustards, and sinigrin, which is typically found in brown/oriental mustards. A processed mustard of the present invention may have sinalbin or sinigrin at a level of at least 0.5% (wt/wt), at least 0.8% (wt/wt), at least 1% (wt/wt), at least 1.5% (wt/wt), at least 2% (wt/wt), at least 2.5% (wt/wt), or at least 3% (wt/wt). Methods for measuring the amount of glucosinolates, such as sinalbin and/or sinigrin, in a mixture such as a mustard powder are known in the art and routinely used. Examples of methods for detection of glucosinolates include, but are not limited to, Chromatographic separation of a glucosinolate using HPLC and a hydrophobic column, such as a C18 column.

A processed mustard useful in the present invention also has the characteristic of having no detectable myrosinase activity. Methods for detecting myrosinase levels are routine and known in the art, and include, for instance, monitoring degradation of a substrate of myrosinase, such as sinalbin or sinigrin.

Thus, as used herein, a “processed mustard” has characteristics that include a total phenol content, an antioxidant capacity, glucosinolates, such as, but not limited to, sinalbin and/or sinigrin, and little or no detectable myrosinase activity.

A processed mustard useful in the methods described herein is generally produced by heating seeds that have been subjected to routine milling, or by heating mustard seeds and subsequently milling the heated seeds. Milled seeds that are dehulled before milling are typically referred to as mustard flour or mustard powder. Milled seeds that are not dehulled before milling are typically referred to as ground mustard. Both mustard powder and ground mustard, or a combination thereof, may be used in the methods described herein.

Any type of mustard seed routinely used in the preparation of mustard products for human consumption may be used to make a processed mustard. Examples include yellow (also referred to as white) mustards, such as Sinapis alba, and often referred to as Brassica alba or B. hirta; black mustards, such as B. nigra; and Oriental mustard, such as B. juncea. A combination of yellow, black, and/or Oriental mustards may be used in the methods described herein. Milled mustards can be produced using routine methods known in the art. Alternatively, milled mustards can be obtained from commercial vendors including G.S. Dunn Limited (Hamilton, Ontario, Canada), Mustard Capital Inc (Gravelbourg, Saskatchewan, Canada), Newly Weds Foods, Edmonton, Alberta, Canada, and Mustard Products and Technologies Inc. (Saskatchewan, Canada).

The heating is carried out under conditions that result in the desired characteristics of total phenol content, antioxidant capacity, glucosinolates level, and myrosinase activity. Heating may be at a temperature of but not limited to, at least 70° C., at least 80° C., at least 90° C., at least 100° C., at least 110° C., or at least 120° C. The time the mustard seeds or milled seeds are exposed to an increased temperature may be, but is not limited to, at least 5 minutes, at least 10 minutes, at least 15 minutes, at least 20 minutes, or at least 25 minutes, and no greater than 50 minutes, no greater than 45 minutes, no greater than 40 minutes, no greater than 35 minutes, or no greater than 30 minutes. The heating may be conducted under atmospheric pressure or increased pressure, which may vary from, for instance, 0.2 kilograms per square centimeter (kg/cm²), at least 0.5 kg/cm², at least 1 kg/cm², at least 2 kg/cm², at least 3 kg/cm², or at least 4 kg/cm². The heating may be accomplished using the conditions generally found in an autoclave, e.g., using steam, or heated under conditions such as found in an oven. An example of heating is in an autoclave at 115° C. for 15 minutes. If mustard seeds are used for heating, the seeds are typically milled to prepare mustard powder or ground mustard before use in the methods of the present invention.

The particle size of the processed mustard after milling may vary. For instance, the particle size may be less than 1 millimeter (mm), less than 0.5 mm, less than 0.1 mm, less than 0.05 mm, less than 0.01 mm, or less than 0.005 mm.

In general, the methods of the present invention do not require modification of the usual types of processes to produce dry and semi-dry fermented sausage. Thus, as is standard practice, desired raw meats are mixed with a starter culture and additional dry ingredients, such as salts, spices, and/or nitrites, to form a sausage batter, and after stuffing into casing the sausage is exposed to conditions suitable for fermentation. Optionally and preferably, after an appropriate time the fermented mixture is exposed to conditions suitable for drying the fermented sausage.

One of the dry ingredients that may be added in standard methods for making a dry or semi-dry fermented sausage is a hot mustard, and less often, a cold mustard. Typically, a hot mustard, if added, is added in small amounts to act as a spice. A cold mustard, if added at all, may be present due to its binding and/or emulsifying characteristics. Hot and cold mustards do not have the characteristics of a processed mustard described herein. As used herein a “hot” mustard is a milled mustard that includes myrosinase enzyme activity. Hot mustards are typically produced by milling mustard seeds to produce mustard powder or ground mustard. Hot mustards are readily available commercially from, for instance, G.S. Dunn Limited. As used herein, a “cold” mustard, is typically a milled mustard that has little to no detectable myrosinase activity. Cold mustards typically have a total phenol content that is no greater than 22 mg FAE/g cold mustard, and an antioxidant capacity of no greater than 1060 micromol TE/100 g cold mustard. Cold mustards are also referred to as deactivated, deheated, or deodorized mustards. Cold mustards may be produced by conventional methods such as hydration (see, for instance, Sakai and Ebisawa, U.S. Pat. No. 4,496,598). Cold mustard is also available commercially from, for instance, G.S. Dunn Limited, where it is typically referred to as “deactivated mustard,” and from Mustard Capital Inc (Gravelbourg, Saskatchewan, Canada), Newly Weds Foods, Edmonton, Alberta, Canada, and Mustard Products and Technologies Inc. (Saskatchewan, Canada), where it is typically referred to as “deheated mustard.”

In some embodiments of the methods of the present invention a processed mustard is added to a sausage batter. The processed mustard may be added at a level of, for instance, at least 0.25%, at least 0.5%, at least 1%, at least 1.5%, at least 2%, or at least 2.5% (wt/wt) of the final sausage batter, and no greater than 7%, no greater than 6%, or no greater than 5% (wt/wt) of the final sausage batter. In accordance with another embodiment, a processed mustard is added to a sausage batter in combination with a hot or a cold mustard, or a combination of both hot and cold mustards. The amount of processed mustard relative to a hot or a cold mustard may be, but is not limited to, at least 30%, at least 40%, or at least 50%, and no greater than 80%, no greater than 70%, or no greater than 60%.

As will be readily recognized by the skilled person, the amount of processed mustard added can be varied to influence the characteristics of the final dry or semi-dry fermented sausage. Such characteristics include, but are not limited to, flavor, color, texture, smell, pH, and water activity. In some preferred aspects, the amount of processed mustard added is sufficient to reduce microbial contamination of the fermented sausage. Examples of microbes that can contaminate fermented sausage include pathogens such as Escherichia coli, including E. coli O157:H7 and other strains of E. coli such as Shiga-toxin producing E. coli (STEC, also referred to as VTEC), members of the genus Staphylococcus, such as S. aureus, members of the genus Campylobacter, such as C. jejuni, members of the genus Pseudomonas, such as P. aeruginosa, members of the genus Salmonella, such as S. enterica, members of the genus Listeria, such as L. monocytogenes, members of the genus Shigella, such as S. boydii and members of the genus Clostridium, such as C. perfringens. Preferably, the amount of processed mustard added, either alone or in combination with a hot or a cold mustard, e.g., a mixture of both processed and hot mustard, is sufficient—in conjunction other processing conditions—to cause a greater than 5 log colony forming unit (CFU) per gram (CFU/g) fermented sausage reduction in E. coli O157:H7 viability.

Following outbreaks of E. coli O157:H7 from the ingestion of fermented sausage products, the Food Safety and Inspection Service of the United States and the Canadian Food Inspection Agency mandated the use of validation systems to provide a high degree of assurance that the process used to produce a fermented sausage will consistently result in a greater than 5 log CFU/g reduction in E. coli O157:H7 viability. Validation studies are routine and known in the art, and may include the use of test tubes (Ellajosyula et al., 1998, J. Food Prot. 61: 152-157); model systems (Tomicka et al., 1997, J. Food Prot. 60: 1487-1492); environmental chambers (Glass et al., 1992, App. Environ. Microbiol. 58: 2513-2516); and commercial-type smokehouses d drying chambers (Hinkens et al., 1996, J. Food Prot. 59: 1260-1266; Getty et al., 1999, J. Food Sci. 64: 1100-1107). Often, testing of a sausage batter before fermentation and the resulting fermented sausage for the presence of E. coli O157:H7 is conducted. Optionally, a sausage batter lot may be prepared with a five-strain mixture of E. coli O157:H7, and the >5 log CFU/g reduction in E. coli O157:H7 viability tested by comparing the CFU/g viable E. coli O157:H7 in the sausage batter and in the resulting fermented sausage. It is expected that use of the methods described herein may abolish any requirement to routinely test fermented sausage products for the presence of pathogenic microbes such as E. coli O157:H7.

The types of meats typically included in a dry or semi-dry fermented sausage include pork and beef, and may also include, but are not limited to, goat, sheep, veal, and buffalo. Starter cultures are routinely used to initiate fermentation during the production of dry and semi-dry fermented sausage, and may include, but are not limited to, one or more lactic acid bacterium, such as Lactobacillus or Pediococcus. A starter culture may also include one or more microbes that act to stabilize the color of the fermented sausage. Examples of such cultures may include, but are not limited to, non-pathogenic Staphylococcus, such as S. carnosus. Starter cultures are commercially available from, for instance, those listed in Table 2 herein. Alternatives are also used, including inoculating the sausage batter with sausage from a prior batch, often referred to as back slopping, to transfer a fermenting microbe from one batch to the next. A variety of dry ingredients may be used, and as will be recognized by the skilled person, can be varied and exposed to various fermentation and drying conditions to result in the desired fermented sausage.

A sausage batter that has been stuffed into casing is exposed to conditions suitable for fermentation. Conditions that are “suitable” for an event to occur, such as fermentation of drying of a sausage, or “suitable” conditions are conditions that do not prevent such events from occurring. Thus, these conditions permit, enhance, facilitate, and/or are conducive to the event. Fermentation of a sausage may include incubation in a temperature and humidity controlled environment. Without intending to be limiting, the temperature of the environment may vary, and may be, for instance, at least 19° C., at least 20° C., at least 21° C., at least 22° C., at least 23° C., at least 24° C., at least 25° C., or at least 26° C. Typically, the temperature of the environment does not go over 32° C. The humidity may vary from, for instance, 88% to 98% relative humidity. The fermentation may include changes of temperature and/or humidity of the environment that decrease or increase during the incubation period. The length of fermentation may vary, and may be from 2 to 5 days, but typically does not exceed the degree*hour requirements to achieve pH 5.3 as set by the USDA and CFIA.

After the fermentation, the fermented sausage is exposed to conditions suitable for drying. Like the conditions for fermentation, the conditions for drying may include incubation in a temperature and humidity controlled environment for a period of time, for instance, between 23 and 58 days. Without intending to be limiting, the temperature of the environment may vary, and may be, for instance, at least 12° C., at least 13° C., at least 14° C., at least 15° C., at least 16° C., at least 17° C., or at least 18° C. Typically, the temperature of the environment does not go over 18° C. The humidity may vary. For instance, humidity may begin at a higher value, such as between 88% and 98%, and then be decreased to a value between, for instance, 75%, 75%, 76%, 77%, 78%, or 79% relative humidity. The drying may include changes of temperature and/or humidity of the environment that decrease or increase during the incubation period. The length of the drying may vary, such as between 15 to 25 days or longer.

The methods of the present invention may optionally include cooking. As used herein, cooking refers to bringing the internal temperature of the fermented meat to at least 69° C. In some embodiments, such as conditions for making dry fermented sausage, cooking is not used.

Typically, at the end of the process, a dry fermented sausage will undergo a moisture loss of up to at least 25% of the original weight, while a semi-dry fermented sausage will undergo a moisture loss of up to at least 15% of the original weight.

Also included in the present invention are fermented sausages. A fermented sausage of the present invention includes pork and/or beef, and may also include, for instance, goat, sheep, veal, and buffalo. It typically has a pH of no greater than 5.3, no greater than 5.0, no greater than 4.7, no greater than 4.4, or no greater than 4.1. The moisture protein ratio of a semi-dry fermented sausage is typically no greater than 3.2:1, no greater than 3:1, no greater than 2.8:1, or no greater than 2.6:1. The moisture protein ratio of a dry fermented sausage is typically no greater than 2:3, no greater than 2:1, no greater than 1.9:1, no greater than 1.7:1, or no greater than 1.5:1. The water activity (a_{w}) of a dry fermented sausage is typically no greater than 0.94, no greater than 0.92, no greater than 0.90, no greater than 0.88, no greater than 0.86, no greater than 0.84, or no greater than 0.82. Examples of semi-dry sausages include, but are not limited to, Summer sausage, Thuringer, Cervelat, Lebanon bologna, Mortadella, and Landjaegar. Examples of dry fermented sausages include, but are not limited to, Chorizo, Pepperoni, Lola, Lyons, and Salamis such as Sopressata and Genoa.

A fermented sausage of the present invention includes protein derived from meat and protein derived from vegetable. Typically, fermented sausages, such as dry fermented sausages, do not contain vegetable protein, or, if present, are at low levels from the addition of spices. In contrast, a fermented sausage of the present invention, before drying, may include vegetable protein at a level of at least 0.01% vegetable protein by weight of the sausage batter used to prepare the fermented sausage (wt/wt), at least 0.05% (wt/wt), at least 0.1% (wt/wt), at least 0.3% (wt/wt), at least 0.5% (wt/wt), at least 0.7% (wt/wt), at least 0.9% (wt/wt), at least 1% (wt/wt), at least 1.5% (wt/wt), at least 2% (wt/wt), or at least 2.5% (wt/wt). The amount of vegetable protein in a fermented sausage can be determined by monitoring the ingredients added to the sausage batter.

A fermented sausage of the present invention, after drying, may include vegetable protein at a level of at least 0.01% vegetable protein by weight of the fermented sausage (wt/wt), at least 0.05% (wt/wt), at least 0.1% (wt/wt), at least 0.3% (wt/wt), at least 0.5% (wt/wt), at least 0.7% (wt/wt), at least 0.9% (wt/wt), or at least 1% (wt/wt). The amount of vegetable protein in a fermented sausage of the present invention may also be expressed as the difference between the total protein and the total protein derived from meat. A fermented sausage of the present invention may include vegetable protein, where the difference between the total protein and the total protein derived from meat is at least 0.5%, at least 1%, at least 1.5%, at least 2%, or at least 2.5%. The amount of vegetable protein and the amount of meat protein in a fermented sausage can be determined using routine methods known in the art.

The present invention is illustrated by the following examples. It is to be understood that the particular examples, materials, amounts, and procedures are to be interpreted broadly in accordance with the scope and spirit of the invention as set forth herein.

### EXAMPLE 1

Illness outbreaks involving Escherichia coli O157:H7 and dry-cured sausage consumption have been reported in a number of countries. North American food regulatory agencies mandate a 5-log reduction of E. coli O157:H7 during the manufacture of these products. Intriguingly, with dry sausage the addition of 6% yellow mustard flour lacking the enzyme myrosinase (and therefore unable to produce antimicrobial isothiocyanates from the glucosinolate, sinalbin, in mustard) was able to cause very significant reduction of the pathogen in only 6 days. From these results three hypotheses have arisen: 1) intrinsic meat enzymes were able to convert the glucosinolate to isothiocyanate; 2) the mustard present in the spice used (at 10%) in the sausage recipe was responsible; or 3) the starter cultures had myrosinase-like activity and found the isothiocyanate. Changes in sinalbin levels were followed for 6 days using HPLC. Results showed that neither the meat enzymes nor the spice mix affected sinalbin concentrations. However, all bacteria tested were able to degrade sinalbin and faun ρ-hydroxybenzyl isothiocyanate. This degradation occurred intracellularly. Separately, the bacteria showed different rates of glucosinolate breakdown, with E. coli O157:H7>Staphylococcus carnosus>Pediococcus pentosaceus. These results suggest that the starter cultures may contribute to E. coli O157:H7 death, and possibly that E. coli O157:H7 may commit suicide by degrading the glucosinolate and releasing the isothiocyanate into the sausage environment.

### Material And Methods

Bacterial Strains. Experiments used a five strain mixture of E. coli O157:H7. The strain LCDC 7283 (pathogenic, hamburger isolate) was provided by Dr. R. Khakria, Laboratory Centre for Disease Control, Ottawa, Canada. Strains 02-0628, 02-0627, 00-0351 and 02-0304 (non-pathogenic, human isolates) were supplied by Rafiq Ahmed, National Microbiology Laboratory, Public Health Agency, Canadian Centre for Human and Animal Health, Winnipeg, MB, Canada. Staphylococcus carnosus (UM 109M) and Pediococcus pentosaceus (UM 116P) were isolated from commercial lyophilized dry-sausage starter culture preparations (Trumark LTII and Trumark LTIIM, respectively; Rector Foods Ltd., Mississauga, Ontario, Canada).

Chemicals. Myrosinase and tetrabutylammonium hydrogen sulfate (TBA) were purchased from Sigma Chemical Co (St. Louis, Mo., USA); sinalbin from C₂ Bioengineering (Copenhagen, DK); acetonitrile HPLC grade from Fisher Scientific Co. (Fair Lawn, N.J., USA) and the deheated yellow mustard flour was provided by G.S. Dunn (Hamilton, ON, Canada). Other chemicals noted were of analytical grade.

Microbial Growth Conditions. All bacteria were incubated in broth for 16 hours at 25° C. prior to the experiments. E. coli O157:H7 (5-strain cocktail) and Staphylococcus carnosus grew in Muller-Hinton broth (MHB) (Oxoid, Unipath, Nepean, ON); Pediococcus pentosaceus grew in deMan, Rogosa and Sharpe (MRS) broth (Oxoid). After the incubation period, 0.1 ml of each bacterial culture was used as the inoculum for subsequent experiments. The final volume of 10 ml in screw-capped tubes was used during all studies.

Degradation of Glucosinolates. Levels of sinalbin were followed for 6 days (samples collected on days 0, 1, 3 and 6) in different sets of experiments: 1) Bacterial growth in MHB containing 0.1% sinalbin was examined (adapted from Brabban and Edwards, 1994. FEMS Microbiology Letters. 119:83-88). 2) Then, the effect of meat enzymes on the degradation of glucosinolates was evaluated using fresh meat exudates in the presence of sinalbin. For that purpose, lean cuts of pork and beef were treated in a stomacher (BagMixer 400, Intersciences Inc., Markham, Ontario, Canada) for 1.5 min in M9 media (Oxoid) (10 grams of meat per 90 ml of M9 media), and the slurry formed was filtered-sterilized (0.22 μM Fisherbrand syringe filter; Fisher Scientific Co.). Sinalbin at 0.1% was added to this solution. 3) The spice mix used by Graumann and Holley (Graumann and Holley, 2008. Journal of Food Protection 71:486-493) was found to contain up to 10% of mustard powder and, therefore, was examined for the presence of myrosinase that could also have been responsible for conversion of glucosinolates to isothiocyanates. A level of 0.44% of the spice mix, which is used in dry-cured sausage recipes, was added to M9 media with 0.1% sinalbin.

HPLC Analysis. Separation and quantification of the glucosinolates was performed using an HPLC equipped with a C18 column (Waters Co., 4.6×250 mm i.d. 5 μm). Elution was carried out isocratically for 20 min at a flow rate of 1 mL/min, using a solvent system containing 20% (v/v) acetonitrile and 80% water+0.02M tetrabutylammonium hydrogen sulfate (pH 5.5). The injection volume used was 10 μl. A detector was used to measure the absorbance at 227 nm in order to verify and quantify the presence of the glucosinolates and its degradation products.

Dry fermented sausage simulation. Muller-Hinton broth containing ingredients present in dry fermented sausages (2.91% salt, 0.31% pickle cure concentrate, 0.1% glucose, 0.05% sodium erythorbate) was prepared in the presence or absence of deheated yellow mustard (2%). Overnight cultures of P. pentosaceus UM 116P, S. carnosus UM 109M and E. coli O157:H7 (5-strain mixture) were inoculated (0.1 ml each) in the experimental broth to achieve a final volume of 10 ml (screw-capped tubes), which was maintained at 25° C. and 200 rpm (Junior Orbit Shaker; Lab-Line Instruments Inc., Melrose Park, Ill., USA). Bacterial populations were followed for 3 days.

Evaluation of extra- and intracellular enzymatic activity. E. coli O157:H7 (5-strain cocktail), S. carnosus and P. pentosaceus were cultivated separately in MH broth containing sinalbin (500 mg/L) for 6 days at 25° C. and 200 rpm. Degradation of glucosinolates by the bacteria was monitored by HPLC. The bacteria were transferred to microcentrifuge tubes (1.5 ml) and centrifuged at 3000 rpm for 15 min. The supernatant was collected, filter sterilized and analyzed for sinalbin (0.5 mg/ml) degradation for 6 days. Any degradation caused by this fraction would be considered to have been from extracellular enzymatic activity. The bacterial pellet was washed with 50 mM phosphate buffer (pH 7.0) and centrifuged again using the conditions previously described. The washing supernatant was discarded and the cells were resuspended again in 1.5 ml of ice-cooled 50 mM phosphate buffer (pH 7.0). Harvested bacteria were treated with a 60 watt High Intensity Ultrasonic Processor (Vibra-Cell 60, Sonics & Materials Inc., Danbury, Conn., USA). A 2 mm probe with 40% vibration output was used for 1.5 min to disrupt E. coli O157:H7 and for 5 min to destroy both S. carnosus and P. pentosaceus (with a cycle of 2 min sonication/2 min rest/2 min sonication/2 min rest/1 min sonication, to avoid heating). The solution was filter-sterilized (0.2 μm filters) and sinalbin at 0.5 mg/ml was added to the tubes. Any degradation of sinalbin by this fraction over the 6 days was considered to have been due to intracellular enzymatic activity.

### Results And Discussion

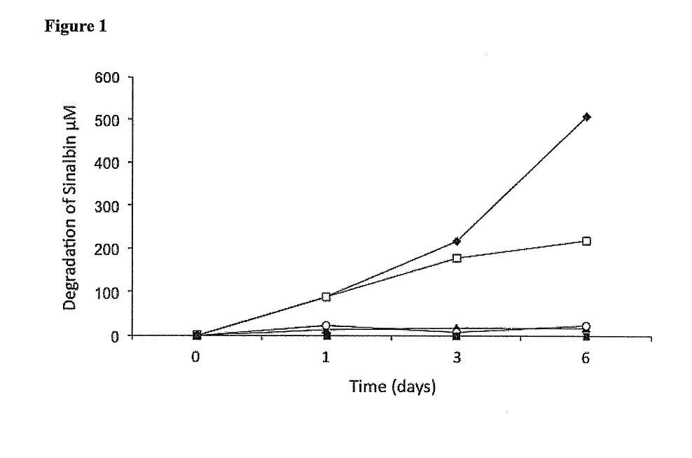

Neither the meat exudates (FIG. 1) nor the spice mix (result not shown) were able to reduce the levels of sinalbin in the media. These results suggest that the enzymes present in meat are not able to hydrolyze sinalbin and form ρ-HBIT. In addition, the mustard present in the spice mix had very little or no myrosinase activity.

Glucosinolate consumption was followed using MHB to improve bacterial growth (FIG. 1). S. carnosus produced a 220.5 μM reduction of the sinalbin levels and P. pentosaceus dropped the levels by 16.4 μM. The 5-strain E. coli cocktail produced the highest amount of glucosinolate degradation (507.9 μM). We have found that that the minimum inhibitory concentration of ρ-HBIT against E. coli O157:H7 at pH levels found in dry-cured sausages (pH 5.5) was ˜600 μM. Formation of isothiocyanates by the starter cultures or E. coli O157:H7 is hard to follow due to the high level of instability of this class of compounds in aqueous systems. The transient formation of ρ-HBIT can be confirmed by the presence of more stable products derived from its reaction with water. These products were ρ-hydroxybenzyl cyanate, ρ-hydroxybenzyl alcohol and the cyanate ion (SCN⁻) (Buskov et al., 2000. Journal of Biochemical and Biophysical Methods. 43:157-174). Conversion of glucosinolates to isothiocyanates by myrosinase was shown to have a yield of up to 90% (Kawakishi and Muramatsu, 1966. Agricultural and Biological Chemistry. 30:688-692). If the decomposition of sinalbin generated by these bacteria follows the same pattern, this reaction will indeed exert an extra hurdle against E. coli O157:H7 growth in the dry-sausage environment, and could possibly cause the death of the pathogen.

Myrosinase-like activity in bacteria has been described before (Brabban and Edwards, 1994. FEMS Microbiology Letters. 119:83-88; Palop et al., 1995. International Journal of Food Microbiology 26:733 219-229; Krul et al., 2002. Carcinogenisis 23:1009-1016; Cheng et al., 2004. Food and Chemical Toxicology. 42:351-357). The starter cultures and, more importantly, E. coli O157:H7 also showed the capacity to degrade glucosinolates. Yellow mustard flour contains 2.5% sinalbin on average, and this results in 3.53 mM sinalbin in a dry sausage containing 6% YMF. This concentration should allow formation of ρ-HBIT in sufficient quantity to be bactericidal to E. coli O157:H7 when combined with other hurdles inherent in the dry sausage.

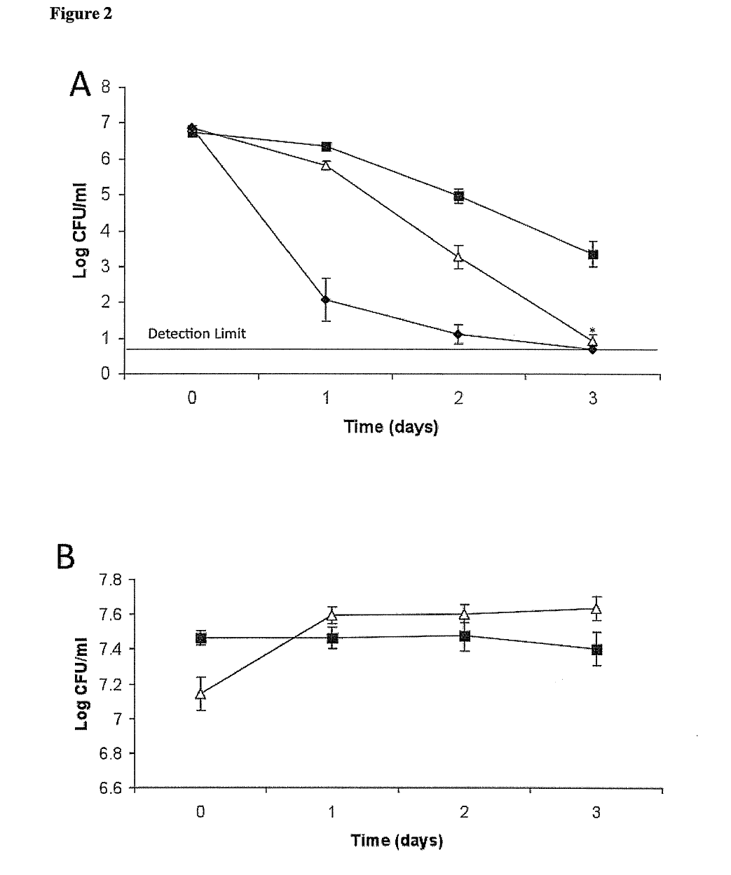

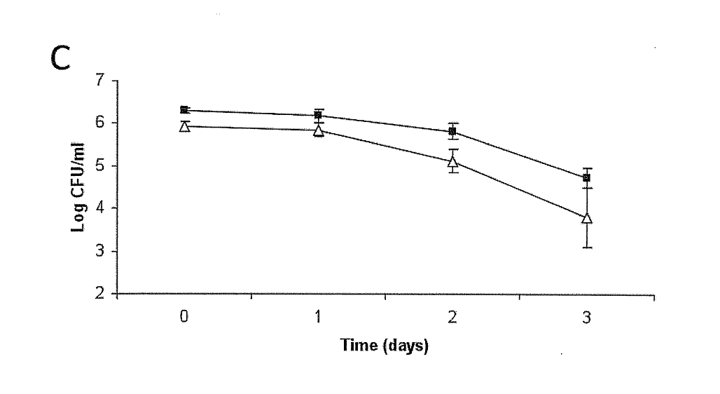

Muller-Hinton broth containing ingredients used to manufacture dry-cured sausage was used to inoculate P. pentosaceus UM 116P, S. carnosus UM 109 or the 5-strain cocktail of E. coli O157:H7. The treated group also received a yellow mustard flour extract (2%). The population of E. coli O157:H7 dropped in both treated and control groups, but it was significantly lower in the treated group (FIG. 2). After 3 days, the population of E. coli O157:H7 decayed >6 log CFU/ml in the treated group, whereas in the control group this reduction was 3.4 log CFU/ml. In addition, P. pentosaceus numbers were maintained during this study, while S. carnosus showed a similar reduction for both groups. A third treatment containing yellow mustard flour extract and myrosinase showed a more abrupt reduction of E. coli O157:H7 numbers. These results suggest that the presence of the yellow mustard flour extract offers an extra hurdle to the survival E. coli O157:H7. In vitro, as in the results shown by Graumann and Holley (Graumann and Holley, 2008. Journal of Food Protection 71:486-493), this extra hurdle may be a result of the bacterial degradation of sinalbin and consequent formation of ρ-HBIT.

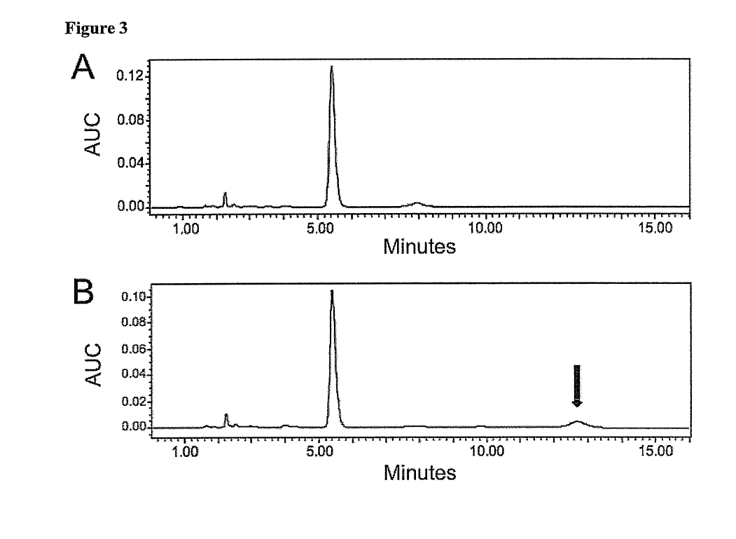

Separate analysis of extracellular culture filtrates and intracellular bacterial fractions prepared by sonication revealed that all bacteria studied had intracellular enzymatic activity capable of degrading sinalbin and forming SCN⁻ (FIG. 3). However, no extracellular myrosinase-like activity was found (result not shown). This result suggests that the bacteria must internalize sinalbin in order to form the isothiocyanate (p-BHIT), which may then react with cell components and/or enzymatic systems, leading to cell death (Luciano and Holley, 2009. International Journal of Food Microbiology 131:240-245).

### Practical Application

The results presented in this example suggest that P. pentosaceus UM 116P, Staphylococcus carnosus UM 109 and, more importantly, E. coli O157:H7 are able to break down sinalbin and presumably convert significant amounts of the glucosinolate to its corresponding isothiocyanate. This conversion helps to explain why deheated yellow mustard flour was able to kill E. coli O157:H7 in dry-cured sausages (Graumann and Holley, 2008. Journal of Food Protection 71:486-493). This pathogen may internally convert sinalbin to ρ-HBIT in order to acquire energy, since a molecule of glucose is released during this reaction. This event is not lethal in normal circumstances, but together with other hurdles present in the dry sausage environment, it may cause E. coli O157:H7 to commit suicide.

### EXAMPLE 2

Use of thermally deodorized (cold) yellow mustard flour in the production of dry fermented sausage has been shown to reduce the levels of Escherichia coli O157:H7 by >5 log CFU/g. Although the cold flour (which contains heat-inactivated myrosinase) cannot form the antimicrobial ρ-hydroxybenzyl isothiocyanate (ρ-HBIT) from the native glucosinolate sinalbin, it was still able to essentially eliminate E. coli (>5 log CFU/g). Recently, it was found that E. coli O157:H7 and some starter cultures possessed myrosinase-like activity, and were able to degrade sinalbin to form ρ-HBIT. In the present study, these same bacteria were tested for their capacity to degrade a similar glucosinolate, sinigrin (found in brown/oriental mustard), and form allyl isothiocyanate (AIT). All three bacteria tested showed myrosinase-like activity towards sinigrin, with decomposition rates in order of: E. coli O157:H7>Staphylococcus carnosus>Pediococcus pentosaceus. The minimum bactericidal concentrations (MBCs) of AIT and ρ-HBIT were also tested. S. carnosus and P. pentosaceus were more sensitive to ρ-HBIT (0.59 and 5.92 mM, respectively), while E. coli O157:H7 was more susceptible to the action of AIT (1.04 mM). E. coli was also challenged following the in vitro formation of AIT or ρ-HBIT by commercial myrosinase. The population of the pathogen was more rapidly reduced by the isothiocyanate derived from sinigrin, supporting the MBC results. In conclusion, it seems that ground, cold black or brown/oriental mustard flour may also be used to prevent the survival of E. coli O157:H7 in dry-fermented sausage.

### Material And Methods

Bacterial Strains. Experiments used a five strain mixture of E. coli O157:H7. The strain LCDC 7283 (pathogenic, hamburger isolate) was provided by Dr. R. Khakria, Laboratory Centre for Disease Control, Ottawa, Canada. Strains 02-0628, 02-0627, 00-0351 and 02-0304 (non-pathogenic, human isolates) were supplied by Rafiq Ahmed, National Microbiology Laboratory, Public Health Agency, Canadian Centre for Human and Animal Health, Winnipeg, MB, Canada. Staphylococcus carnosus (UM 109M) and Pediococcus pentosaceus (UM 116P) were isolated from commercial lyophilized dry-sausage starter culture preparations (Trumark LTII and Trumark LTIIM, respectively; Rector Foods Ltd., Mississauga, Ontario, Canada).

Chemicals. Sinigrin, allyl isothiocyanate, myrosinase (EC 3.2.1.147) and tetrabutylammonium hydrogen sulfate (TBA) were purchased from Sigma Chemical Co (St. Louis, Mo., USA); sinalbin from C₂ Bioengineering (Copenhagen, DK); ρ-hydroxybenzyl isothiocyanate was from Toronto Research Chemicals (North York, ON, Canada); Dimethyl sulfoxide (DMSO) and acetonitrile HPLC grade were from Fisher Scientific Co. (Fair Lawn, N.J., USA). Other chemicals used were of analytical grade.

Degradation of Sinigrin. Bacteria grew in Muller-Hinton broth (MHB) (Oxoid, Unipath, Nepean, ON) containing 0.1% sinigrin (adapted from Brabban and Edwards, 1994. FEMS Microbiology Letters. 119:83-88), and the glucosinolate levels were examined in samples collected at days 0, 1, 3 and 6. Separation and quantification of sinigrin was performed using an HPLC equipped with a C18 column (4.6×250 mm i.d. 5 μm, Waters Co., Milford, Mass., USA). Elution was carried out isocratically for 20 min at a flow rate of 1 mL/min, using a solvent system containing 20% (v/v) acetonitrile and 80% water +0.02M tetrabutylammonium hydrogen sulfate (pH 5.5). The injection volume used was 10 μl. A detector was used to measure the absorbance at 227 nm in order to verify and quantify the presence of sinigrin.

In vitro formation of isothiocyanates. E. coli O157:H7 was grown overnight and re-inoculated in Muller-Hinton broth (MHB) until numbers reached 10⁷-10⁸ CFU/ml (optical density=0.60-0.65). A 0.1 ml sample was drawn from this tube and added to screw-capped tubes containing a mixture of 9.9 ml of MHB, myrosinase (0.2 Units per tube), ingredients used in dry-fermented sausage (0.291 g salt, 0.031 g pickle cure concentrate, 0.01 g glucose, 0.005 g sodium erythorbate) and either sinigrin or sinalbin (2.5 mM). Numbers of viable of E. coli O157:H7 were followed for 4 d by surface plating on violet red bile agar (VRB) (Oxoid).

Minimum bactericidal concentration. The minimum bactericidal concentration (adapted from Kim et al., 1995. Journal of Agricultural and Food Chemistry. 43:2839-2845) of AIT and ρ-HBIT were tested in broth contained in capped glass tubes against E. coli O157:H7 (5-strain cocktail), S. carnosus and P. pentosaceus. Degradation products of ρ-HBIT in water [ρ-hydroxybenzyl alcohol (ρ-HBA), ρ-hydroxybenzyl cyanide (ρ-HBC) and cyanide ion (SCN⁻)] (Choubdar et al., 2010. Journal of Food Science 75:C341-C345) were also tested against E. coli O157:H7. The aromatic compounds ρ-HBIT, ρ-HBA, ρ-HBC were dissolved in DMSO at a final concentration <0.1% to facilitate their dispersion. E. coli grew in Luria Broth (Oxoid), S. carnosus in tryptic soy broth (Oxoid), and P. pentosaceus in de Man, Rogosa and Sharpe broth (Oxoid). Broth was adjusted to pH 5.5 using 0.1 M HCl, and bacteria grew at 25° C. and 200 rpm (Junior Orbit Shaker; Lab-Line Instruments Inc., Melrose Park, Ill., USA). Bacteria were plated after 18 hours and the minimum bactericidal concentration (MBC) of the antimicrobials was calculated. The population of E. coli was enumerated in VRB agar (Oxoid), Staphylococcus in mannitol salt agar (Oxoid) and Pediococcus in de Man, Rogosa and Sharpe agar (Oxoid).

### Results And Discussion

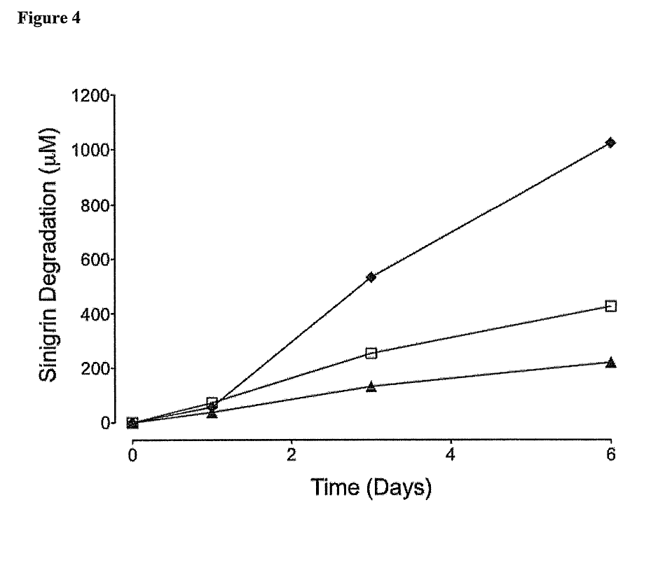

Glucosinolate consumption was followed using MHB to improve bacterial growth (FIG. 4). S. carnosus produced a 425 μM reduction of the sinigrin levels and P. pentosaceus dropped the levels by 297 μM after 6 days. The 5-strain E. coli cocktail yielded the greatest extent of sinigrin degradation (1.02 mM) during the period analyzed. These numbers were superior to those found for the degradation of sinalbin (Example 1), where E. coli O157:H7 decomposed 507.9 μM of the glucosinolate, S. carnosus 220.5 μM and P. pentosaceus 16.4 μM. A previous study showed that the minimum inhibitory concentration of allyl isothiocyanate against E. coli O157:H7 at pH levels found in dry-cured sausages (pH 4.9 to 5.5) was ˜250 μM (Luciano and Holley, 2009. International Journal of Food Microbiology 131:240-245). Quantification of allyl isothiocyanate formation by these bacteria is difficult because of the significant instability of this compound in aqueous systems (Kawakishi and Namiki, 1969. Agricultural and Biological Chemistry. 33:452-459). Conversion of glucosinolates to isothiocyanates by myrosinase is capable of yields reaching 90% (Kawakishi and Muramatsu, 1966. Agricultural and Biological Chemistry. 30:688-692). If the decomposition of sinigrin generated by these bacteria follows the same pattern, this reaction should easily establish an effective hurdle against E. coli O157:H7 survival in the dry sausage environment, and should eliminate the pathogen.

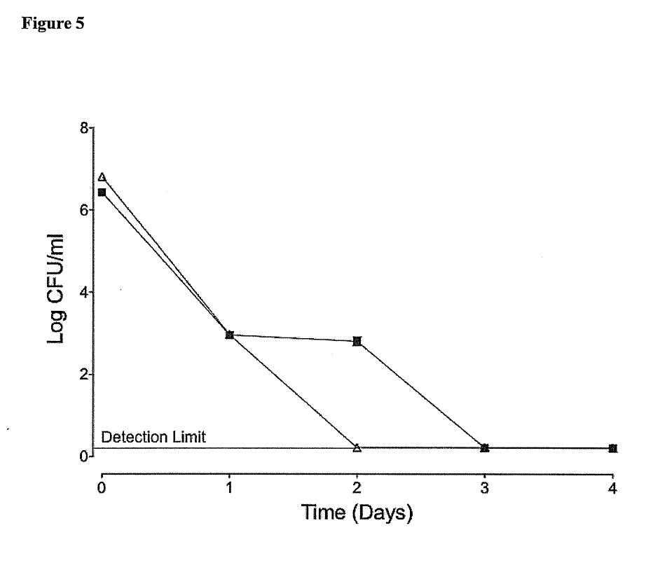

The sensitivity of the three species of bacteria to AIT and ρ-HBIT was also tested. It was clear that P. pentosaceus possess significantly greater resistance to isothiocyanates than E. coli O157:H7 and S. carnosus (Table 1). The latter two organisms had similar sensitivity to AIT (MBC was 1.04 mM), while S. carnosus showed lower resistance to ρ-HBIT than E. coli O157:H7. In contrast with the other two organisms, E. coli O157:H7 was more susceptible to the inhibitory activity of AIT than ρ-HBIT. This result was corroborated by the antimicrobial activity of the isothiocyanates found when they were formed in vitro upon the action of myrosinase. As shown in FIG. 5, E. coli was not detectable after 2 days when challenged by myrosinase plus sinigrin (resulting in the formation of AIT). Similar reduction was achieved only after 3 days when the glucosinolate present was sinalbin (forming ρ-HBIT). Although both antimicrobials led to bacterial death, inhibitory action against the pathogen was faster by the aliphatic isothiocyanate (AIT). Kim and colleagues (Kim and Lee, 2009. Journal of Food Science. 74:M467-M471) reported that aromatic isothiocyanates had stronger antibacterial activity against E. coli than aliphatic derivates, which is in contrast with the findings of the present study. Kim and colleagues (Kim and Lee, 2009. Journal of Food Science. 74:M467-M471) added the isothiocyanates (dissolved in methanol) to paper disks, which were put aside to allow the solvent to dry and they were subsequently applied on the surface of agar containing the bacteria. The zone of inhibition produced was used to indicate antimicrobial potency. Their results showed strong inhibition of all bacteria tested by the aromatic isothiocyanates and no inhibition was observed by the aliphatic compounds. However, the authors did not take in consideration that the aliphatic isothiocyanates were volatile and could have been lost during the period that the paper disk dried before use. The present results indicate that these isothiocyanates do exert mild to strong antimicrobial activity when tests are done under hermetic conditions.

TABLE 1
Minimum bactericidal concentration of AIT and ρ-HBIT against
E. coli O157:H7, S. carnosus and P. pentosaceus.
Hydrolysis products of ρ-HBIT were also tested against E. coli
O157:H7.

| | | | Growth inhibition |
|---|---|---|---|
| Substance | Organism | MBC | (p < 0.05) |
| AIT | E. coli O157:H7 | 1.04 mM | 0.26 mM |
| | Staphylococcus carnosus | 1.04 mM | 0.26 mM |
| | Pediococcus pentosaceus | 20.80 mM | 10.40 mM |
| ρ-HBIT | E. coli O157:H7 | 1.48 mM | 0.59 mM |
| | Staphylococcus carnosus | 0.59 mM | 0.3 mM |
| | Pediococcus pentosaceus | 5.92 mM | 1.48 mM |
| ρ-HBA | E. coli O157:H7 | NA* | 20.14 mM |
| ρ-HBC | E. coli O157:H7 | NA* | 18.78 mM |
| SCN⁻ | E. coli O157:H7 | NA* | NA* |

*NA - concentration not achieved

ρ-Hydroxybenzyl isothiocyanate is highly unstable in aqueous solutions, forming ρ-HBA, ρ-HBC and SCN⁻ depending on the environmental pH (Buskov et al., 2000. Journal of Biochemical and Biophysical Methods. 43:157-174). These hydrolysis products showed very weak (ρ-HBA and ρ-HBC) or no (SCN⁻) inhibitory activity against E. coli O157:H7 (Table 1). Therefore, hydrolysis of ρ-HBIT will result in reduction of its antimicrobial action against this pathogen.

Cold yellow mustard flour was added to dry fermented sausage (Graumann and Holley, 2008. Journal of Food Protection 71:486-493) and to Muller-Hinton broth (in vitro) in order to kill E. coli O157:H7 (Example 1). The bacteria P. pentosaceus UM116 and S. carnosus UM109 were also used in both studies. Levels of S. carnosus significantly declined during the course of these studies (1-2 log CFU/g), while E. coli O157:H7 was reduced to undetectable levels (>6 log CFU/g). In addition, the population of P. pentosaceus remained constant throughout these experiments. Although E. coli and S. carnosus showed similar resistance to isothiocyanates, staphylococci are more resistant to other hurdles found in the dry fermented sausage environment (high salt content and (Incze et al., 1998, Meat Science. 49, Suppl. 1, 169-177). This may partially explain why numbers of S. carnosus were not reduced to the same extent as those of E. coli O157:H7. In addition, E. coli O157:H7 was able to more extensively degrade the glucosinolates than the starter cultures, and thus probably forms greater concentrations of isothiocyanates (Example 1). These newly formed isothiocyantes are thought to quickly react upon the synthesizing organisms, causing bacterial death.

### Practical Application

Cold yellow mustard flour was shown to decrease the levels of E. coli O157:H7 in dry fermented sausage (Graumann and Holley, 2008. Journal of Food Protection 71:486-493). This was at least partially the result of the conversion of sinalbin to ρ-HBIT by the bacteria present in the sausage, especially E. coli O157:H7 (Example 1). In the present study, it was shown that E. coli O157:H7, S. carnosus and P. pentosaceus also have the ability to degrade sinigrin. Comparison of MBC values showed that AIT was significantly more potent than ρ-HBIT against E. coli O157:H7, while the opposite was found for the starter cultures. Formation of isothiocyanates in vitro by myrosinase also demonstrated that AIT was more effective in killing E. coli than ρ-HBIT. These results suggest that cold black (Brassica nigra) or brown/oriental (Brassica juncea) ground mustard could be used in dry fermented sausage for the elimination of E. coli O157:H7. However, it should be noted that the levels of sinigrin in black (0.8%) (Rangkadilok et al., 2000. Scientia Horticulturae. 96:11-26, Rangkadilok et al., 2000. Scientia Horticulturae. 96:27-41) and brown/oriental mustard (0.8%) are usually significantly lower than the levels of sinalbin in yellow mustard (2.5%) (Zrybko et al., 1997. Journal of Chromatography A. 767:43-52).

It appears that when deodorized ground mustard (used as a binder/extender in cooked cured meats) is used in dry sausages it can be converted to an effective E. coli O157:H7 control agent. This pathogen itself acts as the switch to exert this control.

### EXAMPLE 3

An objective of the present study was to screen two genera of lactic acid bacteria (LAB) and three Staphylococcus carnosus strains for myrosinase-like activity. From these, the best glucosinolate-degrading pair was selected for use together as a starter culture for the production of dry sausage. Yellow mustard powder was added to the sausage batter as a source of the glucosinolate sinalbin, and the ability of starter culture myrosinase like activity to eliminate E. coli O157:H7 was investigated. For comparison, myrosinase in mustard powder was inactivated by autoclave (steam under pressure) treatment and the cold, deodorized product was used in parallel as a sausage ingredient. To better understand the origin of bactericidal activity observed against E. coli O157:H7, phenolic content and antioxidant properties of the mustard powders were examined.

### Material And Methods

### Bacterial Strains

Dry fermented sausage was contaminated with a five-strain mixture of E. coli O157:H7, comprising 02-0628, 02-0627, 00-0351, 02-0304 and non-motile 02-1840 (non-pathogenic, human isolates). These strains were supplied by Rafiq Ahmed, National Microbiology Laboratory, Public Health Agency, Canadian Centre for Human and Animal Health, Winnipeg, MB, Canada. Staphylococcus carnosus (UM 109M) and Pediococcus pentosaceus (UM 116P) were isolated (Holley and Blaszyk, 1998. Food Research International 30:513-522) from commercial lyophilized dry sausage starter culture preparations (Trumark LTII and Trumark LTIIM, respectively; Rector Foods Ltd., Mississauga, ON, Canada). In addition, S. carnosus UM 123M and P. pentosaceus UM 121P also used for dry sausage preparation were isolated from the commercial starter culture mixture Lactacel 115 (Microlife Technics, Sarasota, Fla., USA). Sources of other bacteria used for screening of sinalbin degradation are listed in Table 2. Commercial mixtures RM53 and Duploferment 66 were acquired from Rudolf Muller & Co., Giessen, Germany; Rosellac A was from Institute Rosen Inc., Montreal, QC, Canada; Fermentang BN-1 005 was from B. Heller & Co., Bedford Park, Ill., USA; Diversitech and Saga were also obtained from Rector Foods Ltd.; American Type Culture Collection (ATCC, Rockville, Md., USA), and the Centre for Food and Animal Research/Agriculture and Agri-Food Canada (CFAR/AAFC) Ottawa, ON strains of lactic acid bacteria were also used.

TABLE 2
Differences in myrosinase-like activity of single LAB and
S. carnosus strains. monitored by sinalbin degradation
(μM) at 25° C. for 6 d.

| | | Sinalbin |
|---|---|---|
| Bacterial Strain | Source | Degradation |
| L. curvatus #10 | CFAR/AAFC - cured meat | 60.7 |
| | isolate | |
| L. curvatus #15 | CFAR/AAFC - meat isolate | 38.6 |
| L. curvatus ATCC 25601 | ATCC - milk isolate | 115.9 |
| L. curvatus UM133 | RM53* | 135.8 |
| L. plantarum UM131L | Rosellac A* | 99.8 |
| L. plantarum UM134L | Duploferment 66* | — |
| L. plantarum UM135L | Duploferment 66** | 15.0 |
| L. plantarum BN1005 | Fermentang BN-1005* | — |
| P. acidilactici UM104P | Diversitech LPH* | — |
| P. acidilactici UM119P | Diversitech 4P1* | — |
| P. acidilactici UM129P | Rosellac A* | 79.0 |
| P. acidilactici 122P | Lactacel 115* | — |
| P. acidilactici ATCC 8081 | ATCC - fermented milk | — |
| | isolate | |
| P. acidilactici #1228 | Unknown | 73.0 |
| P. pentosaceus 2 UM102 | Diversitech LPH* | 125.6 |
| P. pentosaceus 2 UM105 | Trumark LT II* | 162.3 |
| P. pentosaceus 2 UM108 | Saga* | 142.8 |
| P. pentosaceus 2 UM113 | Diversitech LP* | 146.6 |
| P. pentosaceus 2 UM114 | Trumark LT II* | 106.1 |
| P. pentosaceus 2 UM121P | Lactacel 115* | 282.8 |
| P. pentosaceus 2 UM127P | Rosellac A* | 15.4 |
| S. cornosus UM123M | Lactacel 115* | 250.3 |
| S. cornosus UM135M | RM53* | 151.5 |
| S. cornosus UM136M | Duploferment 66* | 175.1 |

*Commercial meat starter culture isolate
**Same as L. plantarum 134L, but isolated at a different period in time

### Chemicals

Myrosinase (EC 3.2.1.147), ferulic acid, tetrabutylammonium hydrogen sulfate (TBA), Trolox™, Folin-Ciocalteau reagent 2 M, 2,2-diphenyl-1-picrylhydrazyl (DPPH) were purchased from Sigma Chemical Co. (St. Louis, Mo., USA); sinalbin was from C2 Bioengineering (Copenhagen, DK); ρ-HBIT was from Toronto Research Chemicals (North York, ON, Canada); methanol and acetonitrile HPLC grade were from Fisher Scientific Co. (Fair Lawn, N.J., USA). Other chemicals used were of analytical grade.

### Screening For Degradation of Sinalbin

LAB grew in deMan, Rogosa and Sharpe (MRS) broth (Oxoid, Unipath, Nepean, ON, Canada) and Staphylococcus carnosus grew in tryptic soy broth (TSB) (Oxoid) prior to the experiments. Then 0.1 ml of each individual strain was inoculated into 9.9 ml Muller-Hinton broth (MHB) (Oxoid) containing 2.5 mM sinalbin (the method was adapted from Brabban and Edwards, 1994. FEMS Microbiology Letters 119:83-88). Glucosinolate degradation at 25° C. was evaluated by comparing the levels of sinalbin at day 0 and 6. Separation and quantification of sinalbin was performed using an HPLC equipped with a C18 column (4.6×250 mm i.d. 5 μm; Waters Co., Milford, Mass., USA). Elution was carried out isocratically for 20 min at a flow rate of 1 ml/min, using a solvent system containing 20% (v/v) acetonitrile and 80% water +0.02M tetrabutylammonium hydrogen sulfate (pH 5.5). The injection volume used was 10 μL. A UV detector was used to measure the absorbance at 227 nm in order to verify and quantify the presence of sinalbin. The selected starter culture combination was identified as “Starter Culture B” (P. pentosaceus UM 121 P and S. carnosus UM 1 23M) and the starter culture mixture used by Graumann and Holley (Graumann and Holley, 2008. Journal of Food Protection 71:486-493) was named “Starter Culture A” (P. pentosaceus UM 11 6P and S. carnosus UM 1 09M).

### Preparation of Starter Cultures And E. coli O157:H7 For Production of Dry Sausage

The dry fermented sausage was manufactured using the method of Graumann and Holley (Graumann and Holley, 2008. Journal of Food Protection 71:486-493) with some adaptations. Briefly, both S. carnosus and E. coli O157:H7 strains were grown in TSB, whereas P. pentosaceus was cultured in MRS broth. Overnight cultures were transferred to fresh broth and incubated at 35° C. for 16h in 500 ml flasks. Then cultures were centrifuged (Sorvall Instruments RC-5C; DuPont, Newton, Conn., USA) for 20 min at 5,000 rpm/4225×g (Sorvall SLA-3000 rotor). The supernatant was discarded and the bacterial pellet washed with 0.1% (wt/vol) peptone water (Fisher Scientific Co.), and centrifuged again. The supernatant was discarded once again and cultures were resuspended using 50 ml of 0.1% peptone water. Starter cultures were mixed resulting in 100 ml inoculum that was used for the production of the sausages. A 50 ml E. coli O157:H7 cocktail was used as the contaminant inoculum.

### Dry Fermented Sausage Manufacture

Batches of sausage containing “Starter culture A” or “Starter Culture B” were produced on alternate weeks. Each day of production was comprised of 3 treatments: Control (no mustard powder), 6% cold yellow mustard powder and 6% hot yellow mustard powder (Sinapis alba L., G.S. Dunn Ltd., Hamilton, ON, Canada). All treatments were repeated 3 times for each of the two starter culture mixtures. A total of 10 kg of salami batter was produced for each batch of sausage. Fresh lean pork trim, pork back fat and lean beef trim were purchased bi-weekly from a local butcher shop. They were cut or assembled in ˜400 g portions and frozen (−18° C.) until used. The pork and beef meats were tempered overnight at 5° C. prior to production. Fat (17.55%), pork trim (60.63%) and beef (17.55%) were added in decreasing order of fatness to a prechilled (1 to 2° C.) rotating bowl chopper (Titane 40, Dadaux, Bersaillin, France). The frozen pork fat was chopped to ±3 mm particles and the bacteria were added. The P. pentosaceus and S. carnosus mixture and E. coli O1 57:H7 cocktail inocula were added to yield approximately 8, 6, and 6.5 log CFU/g, respectively. The beef and pork trim were added almost simultaneously, and were chopped until 3 mm granules were produced. Then, the dry ingredients were added: salt (2.91% wt/wt; HyGrade, Sifto Canada Corp., Mississauga, ON, Canada), D-glucose (0.60% wt/wt; Sigma Chemical Co.), Cervelat spice mixture code C719 (0.44% wt/wt; Wiberg Corp., Oakville, ON, Canada), pickle cure concentrate as a source of nitrate (0.31% wt/wt; Canada Compound Corp., Winnipeg, MB, Canada) and 0.05% (wt/wt) sodium erythorbate (Canada Compound Corp.). Yellow mustard powder was added near the end of the chopping process at levels of 6% (wt/wt). The sausage batter was transferred to a pre-cooled vacuum stuffer (VF 608, Handtmann, Waterloo, ON, Canada) and mechanically stuffed into water-softened 55 min diameter fibrous casings (Kalle GmbH, Wiesbaden, Germany), resulting in sausages of approximately 500 g each. These sausages were then hung on horizontal aluminum sticks and placed into a single rack automated smokehouse (ASR 1495 EL/ WA) with a programmable temperature, relative humidity (RH) and pH controller (Titan, Maurer AG, Reichenau, Germany). During fermentation sausages were periodically smoked (2 h total). The temperature was initially set at 26° C. for a fast fermentation, and the temperature was programmed to drop by 2° C. every 24 h until 20° C. was reached. After that, the 2° C. decrements occurred every 12 h to 14° C. The RH was initially set at 88% and was decreased to 80% during the first 24h. Another 2% RH decrease occurred after 24 h and the RH was maintained between 75-78% for the reminder of ripening. Sausages were moved to a second temperature and RH-controlled single rack smokehouse (AFR-Fishmaster “Roundair”; Rauch and Warmetchnik GmbH & Corp., Reichenau, Germany) when the smoking cycles were finished and sausages were dried for 34 d at 14° C. and 75% RH. The total production time was 38 d.

### Autoclaved Yellow Mustard Powder

The autoclaved mustard powder was produced using commercial hot ground mustard (G.S. Dunn Ltd.), which was added to a metal tray to form a 2 cm layer and covered with aluminum foil. The powder was then autoclaved for 15 min at 115° C. Stability of sinalbin levels when the flour was added to water confirmed lack of myrosinase activity (result not shown). This flour was added to the salami batter at 6% (wt/wt). A powder containing 50% autoclaved powder and 50% hot powder (auto+hot) was also tested in sausage formulations at the same 6% (wt/wt) concentration in the batter. Sausages containing the autoclaved powder and the auto+hot powder were only formulated with “Starter Culture A”.

### Dry Sausage Sampling And Analysis

Sausages were selected at different intervals during ripening for microbial and physiochemical analyses. The sausage batter was directly sampled after formulation at day 0 and sausages were tested on days 6, 12, 18, 24, 31 and 38. A 25 g sample was aseptically removed from the core of the sausage using sterilized utensils and placed into a stomacher bag (Filtra-bag, VWR, Edmonton, AB, Canada). Then the sample was homogenized using 225 ml 0.1% peptone water (BagMixer 400, Intersciences Inc., Markham, ON, Canada) for 1.5 min. Serial dilutions from 10⁻² to 10⁻⁵ were prepared by pipetting 1 ml of the stomached sample (10⁻¹) into glass tubes containing 9 ml 0.1% peptone water (wt/vol). Samples were then plated with an Autoplate 4000 Spiral Plater (Spiral Biotech, Bethesda, Md., USA). P. pentosaceus was plated on MRS agar (Oxoid); S. carnosus on mannitol salt agar (MSA; Oxoid); and E. coli O157:H7 on sorbitol MacConkey agar (Oxoid) with cefixime and tellurite supplement added (ctSMAC; Oxoid). Inoculated plates were incubated at 35° C. for 24-48 h. A selective enrichment using immunomagnetic separation with Dynabeads (Dynal Biotech, Oslo, Norway) was used when there was no E. coli O157:H7 growth (population <0.62 log CFU/g). The method for immunomagnetic separation was performed according to the manufacturer's instructions. Water activity of sausages was measured using a Novasina AW-Sprint Machine (Axion AG, Pfaffikon, Switzerland). In addition, 20 g samples were homogenized with 180 ml sterilized distilled water in stomacher bags, and pH was analyzed (Accumet Basic pH meter; Denver Instrument Co., Denver, Colo., USA).

### Total Phenol Content And Antioxidant Activity

Samples (200 mg) of cold, hot or autoclaved mustard powder were extracted in 4 mL methanol/water (50:50 v/v) for 30 min in an ultrasonic bath (B-3200R-2, Bransonic® Cleaning equipment Company, Shelton, Conn., USA) for determination of total phenol content (adapted from Gliszczynska-Swiglo et al., 2006. Food Additives and Contaminants 23, 1088-1098). Then samples were centrifuged at 3000 rpm/1643×g (GLC-1 centrifuge, Sorvall, Newton, Conn., USA) for 10 min. The supernatant was diluted 10 times before analysis due to the very high phenol content. Total phenol content was determined using the Folin-Ciocalteau method (Gao et al., 2002. In: Ng, P., Wrigley, C. W. (Eds.), Wheat quality elucidation. AACC Press, St. Paul, Minn., pp. 219-233). Briefly, 0.2 ml aliquots of the extracts were added to 1.5 mL fresh 10-fold diluted Folin-Ciocalteau reagent. The mixture was held for 5 min before the addition of 1.5 ml sodium carbonate solution (60 g/L). The mixture was kept at room temperature for 90 min and the absorbance was read at 725 nm. The extraction solvent (methanol/water, 50:50 v/v) was used as a blank and samples were compared to a standard curve using ferulic acid. Results were expressed in mg ferulic acid equivalents per 100 g of sample. The linearity range of the calibration curve was 0-200 mg (r=0.99).

Antioxidant activity was measured using the 2,2-diphenyl-1-picrylhydrazyl (DPPH) method (modified from Chen and Ho, 1995. Journal of Food Lipids 2:35-46). A 0.3 g mustard powder sample was extracted with methanol (3 ml) for 30 min in an ultrasonic bath. This solution was centrifuged for 10 min at 3000 rpm/1643×g (GLC-1 centrifuge, Sorvall). Then a 10-fold dilution of the supernatant was made prior to the analysis (necessary because of the high antioxidant levels found in the mustard powder). A 0.1 ml aliquot was added to 3.9 ml of a 6.34×10−5 M DPPH solution. The absorbance was recorded at 0 and 30 min at 515 nm (Ultraspec 200, Pharmacia Biotech Piscataway, N.J., USA). The results were compared to a standard as percent of discoloration according to the formula:

Antioxidant activity=[1−(Absorbance_{515 nm}sample t=30 min)/(Absorbance_{515 nm}sample t=0 min)]

The standard curve using Trolox was prepared (25 to 800 μM in methanol) in parallel with the samples. Results were expressed as μM of Trolox equivalents per 100 g of sample.

### Statistical Analyses

The data reported were analyzed by one-way analysis of variance (ANOVA) and statistical differences among treatments were compared using Tukey's test. All values presented are averages from a minimum of 3 experiments conducted in triplicate (n=9). Data are represented by means±SEM. A P value of 0.05 was used as the cut-off for statistical significance.

### Results And Discussion

### Bacterial Screening

Recently it was found that E. coli O157:H7 and some starter cultures possessed myrosinase-like activity, and were able to degrade sinalbin and form ρ-HBIT (Example 1). In the present study, 24 different isolates mainly from commercial starter cultures with some from meat or from the ATCC were screened for their capacity to decompose sinalbin. Of these, 7 strains were P. pentosaceus, 6 were P. acidilactici, 4 were Lactobacillus plantarum, 4 were L. curvatus and 3 were S. carnosus (Table 2). Results showed that most of the bacteria examined were able to cause sinalbin degradation to some extent. However, no strain was able to cause as high an amount of sinalbin decomposition as found for the E. coli O1 57:H7 cocktail (507.9 μM) (Example 1). Coincidently, the LAB and S. carnosus strains with higher myrosinase-like activity were isolated from the same commercial starter culture marketed as Lactacel 115. When compared to the starter culture mixture used by Graumann and Holley (Graumann and Holley, 2008. Journal of Food Protection 71:486-493), the selected S. carnosus U123M had a slightly higher myrosinase-like activity (250.3 μM) than the S. carnosus UM 109M (220.5 μM) (Example 1), whereas the newly-chosen P. pentosaceus UM 121P caused much greater degradation of sinalbin (282.8 μM) than P. pentosaceus UM 116P (16.4 μM) (Example 1). Potentially the selected starter culture mixture (B) had a >2-fold greater ability to decompose sinalbin than the starter culture mixture (A) used by Graumann and Holley (Graumann and Holley, 2008. Journal of Food Protection 71:486-493). Both paired starters were compared for their ability to eliminate ˜6.5 log CFU/g viable E. coli O1 57:H7 during sausage ripening.

Degradation of glucosinolates by LAB has been previously reported (Cheng et al., 2004. Food and Chemical Toxicology 42:351-357; Krul et al., 2002. Carcinogenesis 23, 1009-1016; Example 1, Example 2). Palop et al. (Palop et al., 1995. International Journal of Food Microbiology 26:733 219-229) have also shown that Lactobacillus agilis R16 was able to degrade sinigrin and produce glucose plus allyl isothiocyanate as end products, suggesting that this organism had myrosinase-like activity. It was recently found that this reaction could be harmful to E. coli O157:H7 when the latter was grown under adverse conditions (Example 1). However, it was uncertain whether sufficient isothiocyanate was produced by the starter cultures to be fatal to E. coli O1 57:H7 or if the lethal effect was caused by myrosinase-like activity provided by E. coli itself.

### Effect of Starter Cultures And Different Yellow Mustard Powders

When sausage batches containing hot mustard powder (active myrosinase), cold mustard powder (inactivated myrosinase), autoclaved powder (inactivated myrosinase) and no mustard flour (control) were prepared, both pairs of starter cultures yielded similar results. The a_{w} values were quite similar among most treatments (Table 3), but with the autoclaved powder the a_{w} was significantly higher. Structural changes in this powder may have occurred leading to its higher water-binding capacity. Hampton et al. (Hampton et al., U.S. Pat. No. 3,869,558) reported that the combination of steam +pressure was able to inactivate amylases of wheat, yielding a higher degree of integrity in the starch molecules, which led to better water-binding capacity. High temperatures are usually necessary to inactivate amylases, and this could be why the sausages containing autoclaved mustard powder had higher a_{w} during ripening. Since the supplier did not disclose the industrial process used for deheating mustard, it is possible that a temperature was used that deactivated myrosinase, but was not sufficient to destroy amylase activity. Van Eylen et al. (Van Eylen et al., 2006. Food Chemistry 97, 263-271) found that 10 min at 75° C. or 30 min at 72.5° C. were needed to totally inactivate myrosinase in yellow mustard, and amylases were usually resistant to these temperatures (Hampton et al., U.S. Pat. No. 3,869,558).

TABLE 3
Changes in a_{w} values during fermentation and drying of raw dry sausage. Results represent control (no mustard added) and
treatments with yellow mustard powder (cold, hot, auto and auto + hot) at 6% (wt/wt).

| | Starter Culture A | | | | | Starter Culture B | | |
|---|---|---|---|---|---|---|---|---|
| Time (d) | Control | Cold | Hot | Auto | Auto/Hot | Control | Cold | Hot |
| 0 | 0.955 ± | 0.957 ± 0.002^{A} | 0.954 ± 0.003^{A} | 0.959 ± 0.001^{A} | 0.960 ± 0.001^{A} | 0.958 ± 0.004^{A} | 0.953 ± | 0.955 ± 0.002^{A} |
| | 0.002^{A} | | | | | | 0.003^{A} | |
| 6 | 0.937 ± | 0.935 ± 0.003^{B} | 0.933 ± 0.002^{B} | 0.944 ± 0.002^{AB} | 0.940 ± 0.001^{AB} | 0.938 ± 0.003^{AB} | 0.948 ± | 0.936 ± 0.001^{B} |
| | 0.002^{B} | | | | | | 0.003^{A} | |
| 12 | 0.924 ± | 0.924 ± 0.005^{A} | 0.922 ± 0.005^{A} | 0.928 ± 0.002^{A} | 0.926 ± 0.002^{A} | 0.908 ± 0.003^{AB} | 0.914 ± | 0.902 ± 0.006^{B} |
| | 0.005^{A} | | | | | | 0.002^{AB} | |
| 18 | 0.890 ± | 0.893 ± 0.002^{ABC} | 0.882 ± 0.001^{BC} | 0.909 ± 0.007^{A} | 0.904 ± 0.006^{AB} | 0.879 ± 0.004^{C} | 0.894 ± | 0.885 ± 0.003^{BC} |
| | 0.005^{ABC} | | | | | | 0.005^{ABC} | |
| 24 | 0.866 ± | 0.868 ± 0.003^{B} | 0.869 ± 0.002^{B} | 0.889 ± 0.002^{A} | 0.877 ± 0.004^{AB} | 0.860 ± 0.004^{B} | 0.873 ± | 0.858 ± 0.004^{B} |
| | 0.005^{B} | | | | | | 0.004^{AB} | |
| 31 | 0.850 ± | 0.843 ± 0.004^{BC} | 0.836 ± 0.004^{BC} | 0.876 ± 0.003^{A} | 0.856 ± 0.003^{AB} | 0.830 ± 0.006^{C} | 0.839 ± | 0.827 ± 0.003^{C} |
| | 0.004^{B} | | | | | | 0.007^{BC} | |
| 38 | 0.831 ± | 0.831 ± 0.002^{B} | 0.825 ± 0.002^{BC} | 0.857 ± 0.002^{A} | 0.839 ± 0.002^{AB} | 0.815 ± 0.002^{C} | 0.826 ± | 0.815 ± 0.004^{C} |
| | 0.004^{B} | | | | | | 0.007^{BC} | |

Values represent mean ± standard error of three trials replicated three times (n = 9).
Different letters represent a significant difference (P < 0.05) among treatments in the same row.
Cold contains commercial yellow mustard powder (YMP) with inactivated myrosinase;
Hot contains commercial YMP with active myrosinase;
Auto contains Hot commercial YMP with myrosinase inactivated by autoclave treatment; and
Auto + Hot is a mixture of equal volumes of Auto and Hot powders.
“Starter Culture A” contained P. pentosaceus UM 116P and S. carnosus UM 109M;
“Starter Culture B” contained P. pentosaceus UM 121P and S. carnosus UM 123M.

Differences were found among the pH values of sausages, depending on the presence or absence of mustard powder (Table 4). These differences were not influenced by the type of starter culture and were probably a result of the carbohydrate content present in mustard. Graumann and Holley (Graumann and Holley, 2008. Journal of Food Protection 71:486-493) showed a similar profile. In addition, the ultimate pH drop for all sausages was achieved within the first week and the pH difference between the “cold mustard powder” and control groups did not seem to have a significant effect on the bacterial population at least until day 24.

TABLE 4
Changes in pH values during fermentation and drying of raw dry sausage. Results represent control (no mustard added) and
treatments with yellow mustard powder (cold, hot, auto and auto + hot) at 6% (wt/wt).

| | Starter Culture A | | | | | Starter Culture B | | |
|---|---|---|---|---|---|---|---|---|
| Time (d) | Control | Cold | Hot | Auto | Auto/Hot | Control | Cold | Hot |
| 0 | 5.90 ± 0.03^{A} | 5.95 ± 0.03^{A} | 5.82 ± 0.04^{A} | 5.90 ± 0.05^{A} | 5.90 ± 0.02^{A} | 5.98 ± 0.05^{A} | 5.95 ± 0.05^{A} | 5.99 ± 0.04^{A} |
| 6 | 4.84 ± 0.02^{A} | 4.66 ± 0.01^{BC} | 4.57 ± 0.01^{C} | 4.55 ± 0.02^{C} | 4.51 ± 0.02^{C} | 4.83 ± 0.07^{AB} | 4.60 ± 0.02^{C} | 4.51 ± 0.02^{C} |
| 12 | 4.92 ± 0.05^{A} | 4.58 ± 0.01^{B} | 4.53 ± 0.01^{B} | 4.53 ± 0.05^{B} | 4.50 ± 0.04^{B} | 4.90 ± 0.07^{A} | 4.65 ± 0.01^{B} | 4.59 ± 0.02^{B} |
| 18 | 4.90 ± 0.01^{A} | 4.65 ± 0.03^{B} | 4.60 ± 0.02^{B} | 4.56 ± 0.03^{B} | 4.52 ± 0.02^{B} | 4.96 ± 0.10^{A} | 4.65 ± 0.03^{B} | 4.59 ± 0.03^{B} |
| 24 | 5.00 ± 0.03^{A} | 4.71 ± 0.01^{B} | 4.69 ± 0.01^{BC} | 4.59 ± 0.02^{C} | 4.58 ± 0.02^{C} | 5.01 ± 0.06^{A} | 4.68 ± 0.02^{BC} | 4.62 ± 0.01^{BC} |
| 31 | 4.99 ± 0.03^{A} | 4.68 ± 0.01^{B} | 4.70 ± 0.03^{B} | 4.64 ± 0.03^{B} | 4.59 ± 0.01^{B} | 4.95 ± 0.06^{A} | 4.68 ± 0.01^{B} | 4.62 ± 0.02^{B} |
| 38 | 4.97 ± 0.03^{A} | 4.66 ± 0.01^{B} | 4.66 ± 0.02^{B} | 4.65 ± 0.01^{B} | 4.64 ± 0.01^{B} | 5.01 ± 0.08^{A} | 4.66 ± 0.01^{B} | 4.63 ± 0.01^{B} |

Values represent mean ± standard error of three trials replicated three times (n = 9).
Different letters represent a significant difference (P < 0.05) among treatments in the same row.

Levels of P. pentosaceus were stable throughout the experiments (Table 5), ranging from about 7.5 to 8.7 log CFU/g. These numbers were maintained even in the presence of isothiocyanate produced by myrosinase in the mustard powder itself (hot and auto+hot powders). It has been shown that P. pentosaceus has a 10-fold greater resistance to allyl isothiocyanate and ρ-HBIT than E. coli O157:H7 and S. carnosus (Example 2). This provides an opportunity to use isothiocyanates as antimicrobial agents in dry fermented sausages, since they do not affect the performance of the acidifying bacteria at levels that are bactericidal to E. coli O157:H7. Unfortunately, the presence of isothiocyanate from the hot powder also affected the viability of both strains of S. carnosus (Table 6). Curiously, the cold powder just as significantly decreased the population of S. carnosus UM 123M (Starter Culture B), whereas the viability of S. carnosus UM 109M (Starter Culture A) was maintained. This could have been a result of the greater degradation of glucosinolates by the UM 123M strain, which could compromise its survival. More interestingly, both auto and auto+hot powders caused a ˜3.5 log CFU/g drop in the S. carnosus UM 109M population (Table 5), suggesting that the autoclaved powder may contain other or higher levels of substances with antimicrobial activity against this bacterium.

TABLE 5
Number (Log CFU/g ± SE) of P. pentosaceus recovered during the production of dry fermented sausage. Results represent
control (no mustard added) and treatments with yellow mustard powder (cold, hot, auto and auto + hot) at 6% (wt/wt).

| | Starter Culture A | | | | | Starter Culture B | | |
|---|---|---|---|---|---|---|---|---|
| Time (d) | Control | Cold | Hot | Auto | Auto/Hot | Control | Cold | Hot |
| 0 | 7.96 ± 0.02^{A} | 7.93 ± 0.04^{AB} | 7.89 ± 0.04^{AB} | 7.90 ± 0.03^{AB} | 7.85 ± 0.02^{AB} | 7.80 ± 0.10^{AB} | 7.62 ± 0.18^{B} | 7.80 ± 0.11^{AB} |
| 6 | 8.24 ± 0.04^{BC} | 8.24 ± 0.05^{BC} | 8.67 ± 0.03^{A} | 8.40 ± 0.02^{AB} | 8.41 ± 0.02^{AB} | 8.07 ± 0.06^{BC} | 7.99 ± 0.20^{C} | 8.41 ± 0.09^{AB} |
| 12 | 8.27 ± 0.03^{CD} | 8.16 ± 0.03^{D} | 8.48 ± 0.04^{AB} | 8.38 ± 0.02^{BC} | 8.44 ± 0.03^{ABC} | 8.12 ± 0.07^{D} | 7.94 ± 0.19^{D} | 8.64 ± 0.07^{A} |
| 18 | 8.12 ± 0.03^{BC} | 8.13 ± 0.03^{BC} | 8.56 ± 0.03^{A} | 8.12 ± 0.03^{BC} | 8.03 ± 0.05^{CD} | 7.59 ± 0.10^{E} | 7.77 ± 0.09^{DE} | 8.32 ± 0.12^{AB} |
| 24 | 7.94 ± 0.07^{BC} | 7.80 ± 0.10^{C} | 8.22 ± 0.08^{AB} | 7.91 ± 0.04^{C} | 8.24 ± 0.03^{AB} | 7.93 ± 0.08^{BC} | 7.82 ± 0.18^{C} | 8.45 ± 0.07^{A} |
| 31 | 7.97 ± 0.07^{BC} | 8.18 ± 0.06^{BC} | 8.67 ± 0.04^{A} | 8.05 ± 0.05^{BC} | 8.27 ± 0.08^{B} | 7.87 ± 0.05^{C} | 7.52 ± 0.25^{C} | 8.01 ± 0.18^{BC} |
| 38 | 8.11 ± 0.03^{BC} | 8.08 ± 0.08^{BCD} | 8.72 ± 0.10^{A} | 7.74 ± 0.09^{DE} | 8.35 ± 0.07^{B} | 7.52 ± 0.09^{E} | 8.16 ± 0.26^{BC} | 7.91 ± 0.15^{CD} |

Values represent mean ± standard error of three trials replicated three times (n = 9).
Different letters represent a significant difference (P < 0.05) among treatments in the same row.

TABLE 6
Number (Log CFU/g ± SE) of S. carnosus recovered during the production of dry fermented sausage. Results represent
control (no mustard added) and treatments with yellow mustard powder (cold, hot, auto and auto + hot) at 6% (wt/wt).

| | Starter Culture A | | | | | Starter Culture B | | |
|---|---|---|---|---|---|---|---|---|
| Time (d) | Control | Cold | Hot | Auto | Auto/Hot | Control | Cold | Hot |
| 0 | 6.16 ± 0.11^{AB} | 6.54 ± 0.06^{A} | 6.46 ± 0.04^{A} | 6.23 ± 0.04^{AB} | 6.20 ± 0.03^{AB} | 6.54 ± 0.04^{A} | 6.32 ± 0.09^{AB} | 5.87 ± 0.20^{B} |
| 6 | 5.94 ± 0.10^{A} | 5.92 ± 0.08^{A} | 5.21 ± 0.20^{CD} | 5.49 ± 0.03^{BC} | 4.92 ± 0.10^{D} | 6.14 ± 0.05^{A} | 5.97 ± 0.06^{A} | 5.95 ± 0.03^{A} |
| 12 | 6.08 ± 0.05^{A} | 5.89 ± 0.06^{AB} | 5.09 ± 0.30^{CD} | 5.01 ± 0.12^{CD} | 4.57 ± 0.09^{D} | 6.08 ± 0.09^{A} | 5.32 ± 0.19^{BC} | 5.96 ± 0.04^{A} |
| 18 | 6.12 ± 0.06^{A} | 5.97 ± 0.08^{AB} | 5.11 ± 0.23^{C} | 3.89 ± 0.07^{D} | 3.97 ± 0.16^{D} | 6.16 ± 0.06^{A} | 5.23 ± 0.19^{C} | 5.62 ± 0.06^{BC} |
| 24 | 5.50 ± 0.19^{AB} | 5.84 ± 0.11^{A} | 4.80 ± 0.25^{B} | 3.48 ± 0.24^{C} | 2.44 ± 0.21^{D} | 5.99 ± 0.02^{A} | 5.26 ± 0.18^{AB} | 5.50 ± 0.08^{AB} |
| 31 | 5.88 ± 0.06^{A} | 5.69 ± 0.07^{A} | 4.82 ± 0.33^{C} | 3.54 ± 0.14^{C} | 2.63 ± 0.11^{D} | 5.93 ± 0.06^{A} | 4.69 ± 0.29^{B} | 4.54 ± 0.24^{B} |
| 38 | 6.12 ± 0.06^{A} | 5.93 ± 0.09^{A} | 4.99 ± 0.31^{BC} | 2.65 ± 0.11^{D} | 2.80 ± 0.08^{D} | 5.41 ± 0.10^{AB} | 4.48 ± 0.24^{C} | 4.70 ± 0.22^{BC} |

Values represent mean ± standard error of three trials replicated three times (n = 9).
Different letters represent a significant difference (P < 0.05) among treatments in the same row.
See table 2 for individual culture identity.

A reduction of E. coli O1 57:H7 viability by >5 log CFU/g occurred after 31 days in the presence of hot flour and 38 d when the cold flour was added (Table 7). The same extent of pathogen reduction in the control group did not occur within 38 days. The results for the hot powder addition were only slightly different from those observed by Graumann and Holley (Graumann and Holley, 2008. Journal of Food Protection 71:486-493), but the outcome of cold powder addition to the dry sausages was very different. The latter authors found a >5 log CFU/g reduction in 6 days and the only major variance between their experiment and the present one was the source of mustard powder. Differences in mustard variety and/or processing to inactivate myrosinase could be the reasons for such a difference.

TABLE 7
Number (Log CFU/g ± SE) of E. coli O157:H7 recovered during the production of dry fermented sausage. Results represent
control (no mustard added) and treatments with yellow mustard powder (cold, hot, auto and auto + hot) at 6% (wt/wt).

| | Starter Culture A | | | | | Starter Culture B | | |
|---|---|---|---|---|---|---|---|---|
| Time (d) | Control | Cold | Hot | Auto | Auto/Hot | Control | Cold | Hot |
| 0 | 6.12 ± 0.04^{B} | 6.34 ± 0.09^{A} | 6.63 ± 0.06^{A} | 6.50 ± 0.05^{A} | 6.06 ± 0.07^{B} | 6.40 ± 0.06^{A} | 6.43 ± 0.07^{A} | 6.51 ± 0.04^{A} |
| 6 | 5.01 ± 0.04^{A} | 4.86 ± 0.07^{A} | 3.67 ± 0.20^{B} | 3.16 ± 0.12^{C} | 2.39 ± 0.36^{D} | 5.21 ± 0.08^{A} | 5.12 ± 0.06^{A} | 3.93 ± 0.08^{B} |
| 12 | 4.70 ± 0.06^{A} | 4.86 ± 0.06^{A} | 3.38 ± 0.09^{B} | 2.35 ± 0.13^{C} | 1.75 ± 0.11^{D} | 4.67 ± 0.10^{A} | 4.67 ± 0.14^{A} | 3.00 ± 0.14^{B} |
| 18 | 4.32 ± 0.06^{A} | 4.05 ± 0.10^{A} | 2.39 ± 0.16^{B} | 1.40 ± 0.01^{C} | <0.62^{D+} | 4.39 ± 0.22^{A} | 4.26 ± 0.21^{A} | 1.88 ± 0.18^{BC} |
| 24 | 3.64 ± 0.14^{A} | 2.92 ± 0.10^{B} | 1.81 ± 0.19^{C} | <0.62^{D+} | <0.62^{D+} | 3.39 ± 0.11^{AB} | 3.24 ± 0.16^{AB} | 1.65 ± 0.01^{C} |
| 31 | 3.21 ± 0.19^{A} | 1.60 ± 0.13^{B} | <0.62^{C+} | <0.62^{C+} | <0.62^{C+} | 3.33 ± 0.23^{A} | 2.15 ± 0.05^{B} | <0.62^{C+} |
| 38 | 2.51 ± 0.10^{A} | 1.37 ± 0.09^{B} | <0.62^{C+} | <0.62^{C+} | <0.62^{C+} | 2.15 ± 0.05^{A} | <0.62^{C+} | <0.62^{C+} |

Values represent mean ± standard error of three trials replicated three times (n = 9).
Different letters represent significant difference (P < 0.05) among treatments in the same row.
⁺Presence of presumptive E. coli O157:H7 was confirmed using immunomagnetic separation and enrichment.

Sausages containing cold powder and the “Starter Culture B” showed a significant difference in the reduction of E. coli O157:H7 in comparison to the same treatment with “Starter Culture A” on day 38. Although this difference was statistically significant, it did not seem that the much higher degradation of sinalbin by “Starter Culture B” played a major role in causing E. coli 0157:H7 death. It is very well known that ρ-HBIT is extremely reactive (Choubdar et al., 2010. Journal of Food Science 75:C341-C345; Kawakishi et al., 1967. Agricultural and Biological Chemistry 31:823-830), and therefore, could interact with different meat components (Luciano et al. 2008. Journal of Food Science. 73: M214-220) or against the starter cultures themselves before it could influence E. coli O157:H7 survival. It has also been reported that E. coli 0157:H7 has intracellular myrosinase-like activity (Example 1), which could lead to formation of the isothiocyanate within the cell and, consequently, cause rapid inhibition of metabolic activity (Kojima and Ogawa, 1971. Journal of Fermentation Technology 49, 740-746; Luciano and Holley, 2009. International Journal of Food Microbiology 131, 240-245) and destruction of cellular components, i.e. cell membrane (Alin et al., 2001. Food Science and Biotechnology 10:31-35; Lin et al. 2000. Journal of Food Protection 63, 727-734).

The autoclaved powder and the combination of autoclaved plus hot powders showed a much more pronounced capacity for killing E. coli O157:H7 (Table 6). This bacterium was reduced to levels below the detection limit (0.62 log CFU/g) of this experiment within 18 d for the auto+hot powder and 24 d for the autoclaved powder alone (although complete elimination did not occur; E. coli O157:H7 presence was confirmed by immunomagnetic separation and enrichment). However, a 5 log CFU/g reduction was found for both powders after 18 d, and if used as a sausage ingredient, they would bring the process in compliance with Canadian and US regulations for the production of dry fermented sausage.

### Total Phenolics And Antioxidant Activity

It seems that the autoclave process was able to release and/or form compounds with antimicrobial activity that had a synergistic or additive effect on the bactericidal activity of ρ-HBIT. Levels of sinalbin were essentially identical for the cold and autoclaved mustard powders (result not shown), suggesting another agent(s) was involved in causing the death of E. coli O157:H7 and S. carnosus.

Several studies have reported that steam treatment was able to release phenolic acids from biological material, yielding greater antioxidant activity; i.e. mushrooms (Ju et al., 2010. Food Chemistry 119:619-625), broccoli (Gliszczynska-Swiglo et al., 2006. Food Additives and Contaminants 23, 1088-1098), wheat, buckwheat, corn and oats (Rhandir et al., 2008. Innovative Food Science & Emerging Technologies 9:746 355-364). The antimicrobial activity of phenolic acids against various bacteria, including E. coli O157:H7, has been previously reported (Lacombe et al., 2010. International Journal of Food Microbiology, 139:102-107).

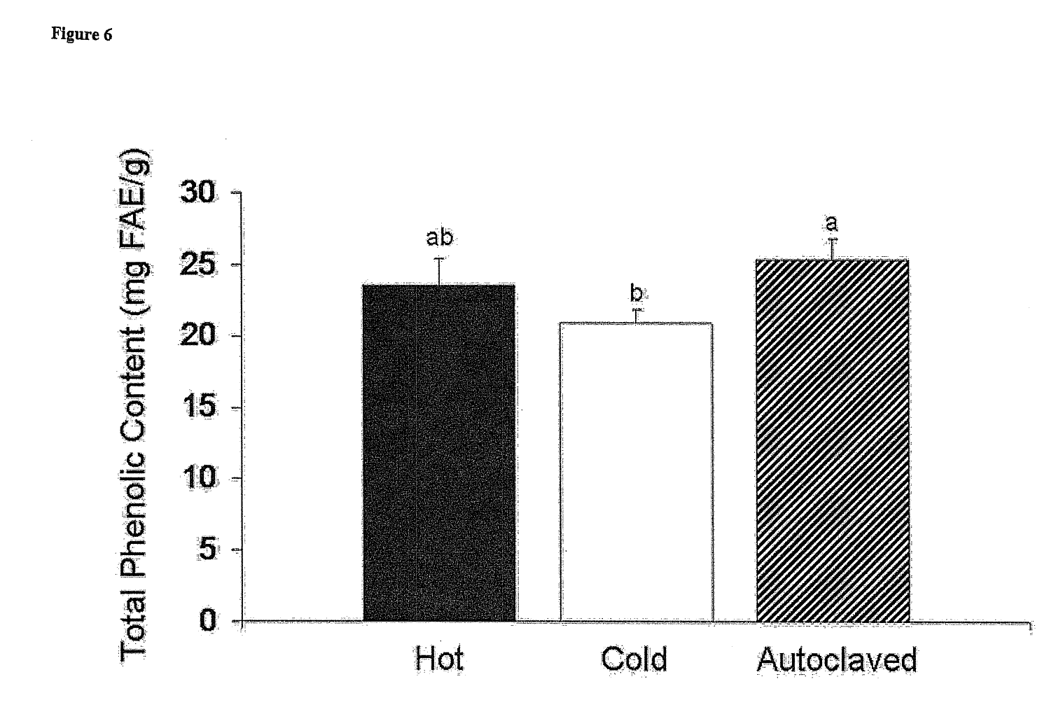

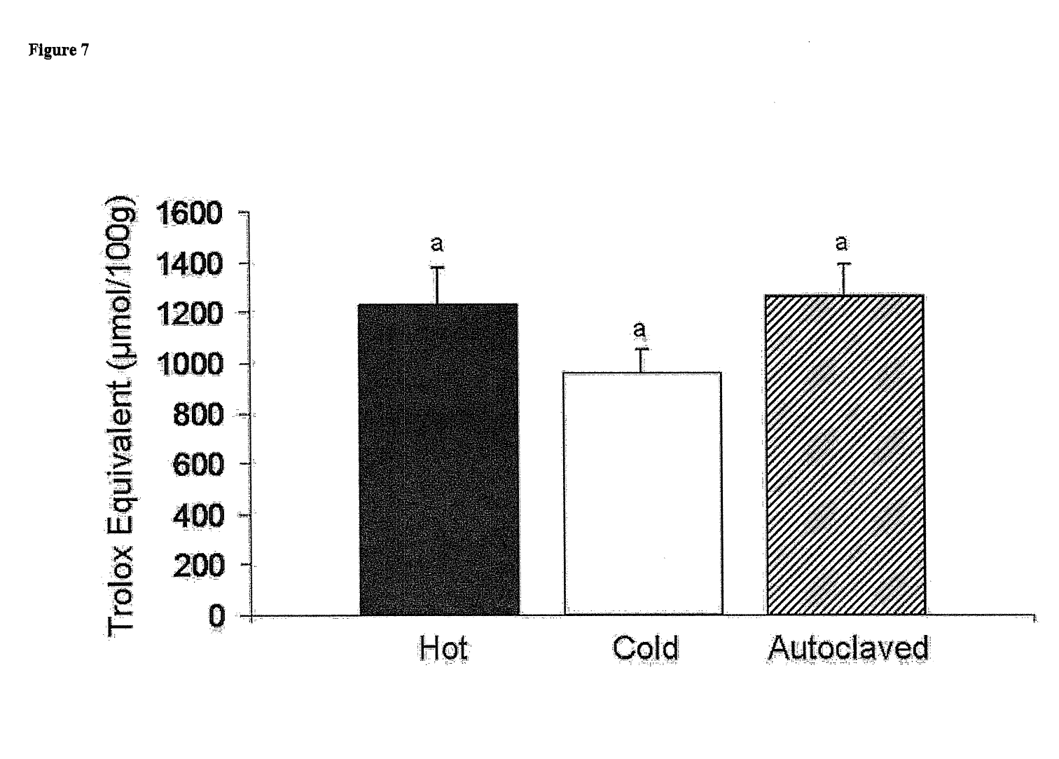

When the autoclaved, cold and hot mustard powders were tested for their total phenolic content, the autoclaved powder was found to have the highest level of phenols, followed by the hot powder and lastly the cold powder (FIG. 6). Although the autoclaved powder possessed the greatest amount of phenols, the level was only significantly higher than that in the cold mustard powder. This could be one of the reasons for the stronger antimicrobial effect of the autoclaved powder towards E. coli O157:H7. In addition, the higher phenolic content of the autoclaved and hot mustard powders could be the reason for the more intense antioxidant activity in comparison to the cold powder (FIG. 7). Dobrowski and Sosulski (1984) showed that mustard contained one of the highest levels of phenolics among 10 different oilseeds, and mustard powder has also been used to retard the oxidation of meat products (Shahidi et al., 1992. In: Ho et al., (Eds.). Phenolic Compounds in Foods and Their Effect on Health. ACS Symposium Series 506, Washington, pp. 214-222).

Some of the issues that might be predicted for sausages containing autoclaved flour are oxidation and discoloration due to the lower population of S. carnosus (Papamanoli et al., 2002. Food Microbiology 19, 441-449). One of the main reasons for the addition of this bacterium to the sausage batter is its capacity to produce catalase, which degrades the hydrogen peroxide produced by catalase negative LAB (Mauriello et al., 2004. Meat Science 67, 149-158). Besides causing rancidity, hydrogen peroxide can react with myoglobin and cause discoloration of meat (Hugas and Monfort, 1997. Food Chemistry 59, 547-554). However, the autoclaved mustard powder was shown to contain high levels of antioxidants, which could probably inactivate the hydrogen peroxide, preventing alteration in color or rancidity.

### Conclusions

The diverse LAB and S. carnosus screened had the ability to degrade sinalbin to some extent. The most active pair of LAB +S. carnous was selected and used to produce dry fermented sausage. However, it did not seem that starter culture myrosinase-like activity played a very significant role in the elimination of E. coli O157:H7. This pathogenic bacterium previously was found to decompose much higher amounts of glucosinolates than the starter cultures (Example 1), which could be the major factor contributing to its own destruction when cold yellow mustard powder was present. E. coli O157:H7 is faced with a variety of hurdles in the dry sausage environment, which make it a weak competitor for nutrients in comparison to S. carnosus, and especially P. pentosaceus. The pathogen may then use sinalbin as a source of energy and inadvertently form ρ-HBIT, which is lethal (Example 2).

The autoclaved mustard powder was found to be more effective in killing E. coli O157:H7 than the cold and hot powders alone. The autoclave process was found to sustain the levels of glucosinolate in the powder (results not shown), but it increased the levels of phenolic acids. The latter compounds also exhibit antimicrobial activity, and may have acted simultaneously with the bacterially-formed isothiocyanate to kill E. coli O157:H7. It is also possible that other substances were formed or released during the autoclave process which could have contributed to the anti-E. coli activity of the powder. Rufian-Henares and Morales (Rufian-Henares and Morales, 2006. Food Research International 39:33-39) reported that Maillard reaction products have antimicrobial activity. The autoclaved mustard powder definitely had a visually darker color than either cold or hot powders, and the autoclave process could also have formed Maillard reaction products. In summary, both autoclaved and mixed autoclaved+hot powders were able to cause a >5 log CFU/g reduction in E. coli O157:H7 viability within a suitable period (30 d) for commercial dry sausage production (Graumann and Holley, 2008. Journal of Food Protection 71:486-493). However, further studies using one or more shiga-toxin producing E. coli O157:H7 strains that caused human illness from contaminated dry sausage may be used for validation of the industrial use of mustard powder (Health Canada, 2000. Interim guidelines for the control of verotoxinogenic Escherichia coli including E. coli O157:H7 in ready to eat fermented sausages containing beef or a beef product as an ingredient. Guideline no 652 12, issued by the Food Directorate, Health Protection Branch).

The complete disclosure of all patents, patent applications, and publications, and electronically available material cited herein are incorporated by reference in their entirety. Supplementary materials referenced in publications (such as supplementary tables, supplementary figures, supplementary materials and methods, and/or supplementary experimental data) are likewise incorporated by reference in their entirety. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

What is claimed is:

1. A method for producing a fermented sausage comprising:
adding to a sausage batter a processed mustard to form an unfermented mixture, wherein the processed mustard comprises characteristics chosen from a total phenolic content of at least 21 mg FAE/gram processed mustard, an antioxidant capacity of at least 900 micromol/100 grams processed mustard, no detectable myrosinase activity, or a combination thereof;
incubating the unfermented mixture under conditions suitable for fermentation to result in a fermented mixture;
incubating the fermented mixture under conditions suitable for drying the fermented mixture to produce a fermented sausage.

2. The method of claim 1 wherein the processed mustard is added to the sausage batter as a composition, wherein the composition comprises processed mustard and a hot mustard or a cold mustard.

3. The method of claim 2 wherein the composition comprising processed mustard and the hot mustard or the cold mustard comprises at least 50% (wt/wt) processed mustard.

4. The method of claim 1 wherein the processed mustard comprises a total phenol content of at least 23 mg FAE/gram processed mustard.

5. The method of claim 1 wherein the processed mustard comprises an antioxidant capacity of at least 1200 micromol/100 grams processed mustard.

6. The method of claim 1 wherein the method further comprises testing for the presence of a pathogenic microbe.

7. The method of claim 6 wherein the unfermented mixture is tested.

8. The method of claim 6 wherein the fermented sausage is tested.

9. The method of claim 6 wherein the pathogenic microbe is chosen from E. coli, a member of the genus Staphylococcus, a member of the genus Campylobacter, a member of the genus Pseudomonas, a member of the genus Salmonella, a member of the genus Listeria, a member of the genus Shigella, a member of the genus Clostridium, and a combination thereof.

10. The method of claim 9 wherein the E. coli is E. coli O157:H7.

11. The method of claim 1 wherein the fermented sausage has a pH of no greater than 5.3.

12. The method of claim 1 wherein the fermented sausage has a water activity of no greater than 0.9.

13. The method of claim 1 wherein the fermented sausage has a moisture protein ratio of no greater than 3.2:1.

14. The method of claim 1 wherein the fermented sausage has a moisture protein ratio of no greater than 1.9:1.

15. The method of claim 1 wherein the processed mustard is produced by exposing a mustard comprising myrosinase to a temperature of between 70° C. and 120° C.

16. The method of claim 1 wherein the processed mustard is produced by exposing a mustard comprising myrosinase to a temperature of at least 70° C. for at least 5 minutes.

17. The method of claim 1 wherein the adding further comprises adding a composition comprising a fermenting microbe.

18. The method of claim 14 wherein the fermenting microbe is a lactic acid microbe.

19. A fermented sausage comprising a processed mustard, wherein the fermented sausage comprises vegetable protein at a level of at least 0.01% (wt/wt).

20. The fermented sausage of claim 19 wherein the fermented sausage is a dry fermented sausage.

21. A fermented sausage comprising a processed mustard, wherein the fermented sausage comprises vegetable protein, wherein the difference between the total protein and the total protein derived from meat is at least 0.5%.

22. The fermented sausage of claim 21 wherein the fermented sausage is a dry fermented sausage.
